(19) United States
(12) Patent Application Publication
(10) Pub. No.: US 2008/0313439 A1
(43) Pub. Date: Dec. 18, 2008

(54) PIPELINE DEVICE WITH A PLURALITY OF PIPELINED PROCESSING UNITS

(75) Inventor: Yousuke SUZUKI, Toyota-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/138,723

(22) Filed: Jun. 13, 2008

(30) Foreign Application Priority Data
Jun. 15, 2007 (JP) 2007-158791

(51) Int. Cl. G06F 9/38

(52) U.S. Cl. 712/225; 712/E09.062

(57) ABSTRACT

In a pipeline device, the output of each of processing units is connected to a corresponding one of data output lines of data transfer lines. Input selectors are provided for the processing units, respectively. Each input selector selects one of the data transfer lines except for one data output line to which the output of a corresponding one processing unit is connected to thereby determine one of interconnection patterns among the processing units. The interconnection patterns correspond to data-processing tasks, respectively. Each input selector inputs, to a corresponding one of the processing units, data flowing through the selected one of the data transfer lines. Each processing unit individually performs a predetermined process based on data inputted thereto by a corresponding one of the input selectors to thereby perform, in pipeline, one of the data-processing tasks corresponding to the determined one of the interconnection patterns.

### CROSS REFERENCE TO RELATED APPLICATIONS

This application is based on Japanese Patent Application No. 2007-158791 filed on Jun. 15, 2007. The descriptions of the Patent Application are all incorporated herein by reference.

### FIELD OF THE INVENTION

The present invention relates to pipeline devices each with a plurality of processing units (stages) each designed to perform a data-processing task in pipeline. Specifically, the plurality of processing units are designed to parallely operate (individually operate) to perform a data-processing task in several steps, like an assembly line in a factory.

### BACKGROUND OF THE INVENTION

Hardware-based image-processing approaches and software-based image-processing approaches are commonly used. One example of the hardware-based image processing approaches is disclosed in the non-patent document “Compact Image Recognition Unit NVP-935 Software Development Kit Users Guide Version 1.6” (“Summary of Pipeline Processing” of the Chapter 9.2).

You can retrieve the non-patent document by visiting the following URL

http://www.kitasemi.renesas.com/product/vp/download/nvp/nvp935#u ser.pdf as of Jun. 1, 2007.

The hardware-based image-processing approaches are typically designed to fabricate a dedicated hardware device by mounting, on a chip, an image-processing circuit to execute a predetermined image-processing task in pipeline.

The hardware-based image-processing approaches are appropriate for high-speed execution of a fixed image-processing task, but limited in use because the fabricated hardware-design thereof fixes an image-processing task to be executable. For this reason, a dedicated hardware device for executing a predetermined image-processing task cannot be used to execute another image-processing task, and therefore, flexibility in using the hardware-based image-processing approaches may be reduced.

On the other hand, the software-based image-processing approaches are typically designed to implement programmed logics for executing a predetermined image-processing task. The programmed logics can be changed to meet the specifications of one or more image-processing task to be executed by the software-based image-processing approaches. For this reason, the software-based image-processing approaches normally have flexibility higher than the hardware-based image-processing approaches, but they normally have processing speed lower than the hardware-based image-processing approaches.

As described above, the hardware-based image-processing approaches and software-based image-processing approaches each have advantages and disadvantages set forth above. Designers conventionally work to construct image-processing systems appropriately using the hardware-based image-processing approaches and software-based image-processing approaches while making use their advantages.

In the hardware-based image-processing approaches, a plurality of image-processing circuits for achieving various desired purposes can be installed in a single hardware device. Selectively use one of the plurality of image-processing circuits allows a plurality of image-processing tasks to be carried out.

Many image-processing tasks require, during their executions, common image-processing circuits. In order to carry out such image-processing tasks with a single hardware device, the common image-processing circuits are redundantly installed in the single hardware device.

For example, smoothed images or gradient images are commonly generated by a convolution unit.

Specifically, referring to FIG. 20A, an intensity value Po [x, y] in an x-y dimensional smoothed image or an x-y dimensional gradient image at the coordinate point (x, y) can be expressed by the following equation using a convolution unit with a 3×3 convolution matrix (kernel coefficient matrix) H:

$$Po [ x , y ] = Pi [ x - 1 , y - 1 ] \cdot h [ - 1 , - 1 ] + Pi [ x , y - 1 ] \cdot h [ 0 , - 1 ] + Pi [ x + 1 , y - 1 ] \cdot h [ 1 , - 1 ] + Pi [ x - 1 , y ] \cdot h [ - 1 , 0 ] + Pi [ x , y ] \cdot h [ 0 , 0 ] + Pi [ x + 1 , y ] \cdot h [ 1 , 0 ] , Pi [ x - 1 , y + 1 ] \cdot h [ - 1 , 1 ] + Pi [ x , y + 1 ] \cdot h [ 0 , 1 ] + Pi [ x + 1 , y + 1 ] \cdot h [ 1 , 1 ]$$

where the kernel coefficient matrix H consists of “h [−, −1], h [0, −1], h [1, −1], h [−1, 0], h [0, 0], h [1, 0], h [−1, 1], h [0, 1], and h [1, 1]”, and Pi [x, y] represents an intensity value in an x-y dimensional input image G [x, y] at the coordinate point [x, y].

Referring to FIG. 20B, setting “ 1/9” to each value of the 3×3 kernel coefficient matrix H allows an intensity value Po [x, y] in the input image data G[x, y] to be smoothed to an averaged value of the 3×3 intensity values Pi [x−1, y−1, Pi [x, y−1], Pi [x+1, y−1], Pi [x−1, y], Pi [x, y], Pi [x+1, y], Pi [x−1, y+1], Pi [x, y+1], and Pi [x+1, y+1]. In other words, the convolution unit allows a smoothed image to be generated based on the input image G [x, y].

Similarly, setting “−1, −2, −1, 0, 0, 0, 1, 2, and 1” to the respective values “h [−1, −1], h [0, −1], h [1, −1], h [−1, 0], h [0, 0], h [1, 0], h [−1, 1], h [0, 1], and h 1, 1]” of the 3×3 kernel coefficient matrix H allows an intensity value Po [x, y] in a gradient image in the x direction to be obtained. In addition, setting, to “[−1, 0, 1, −2, 0, 2, −1, 0, and 1”, the respective values “h [−1, −1], h [0, −1], h [1, −1], h [−1, 0], h [0, 0], h [1, 0], h [−1, 1], h [0,1], and h[1, 1]” of the 3×3 filter coefficient allows an intensity value Po [x, y] in a gradient image in the y direction to be obtained.

Change in the kernel coefficient matrix H of the common convolution unit can generate smoothed images and gradient images. Generation of such smoothed images and/or gradient images are needed in various image-processing tasks including a preprocessing task of a gradient method for optical-flow estimation, an edge-detection task, and a preprocessing task of labeling.

In order to carry out a plurality of image-processing tasks with a single hardware device, a plurality of image-processing circuits each corresponding to one of the image-processing tasks can be installed in the single hardware device.

However, this approach may increase the single hardware device in size and cost.

Regarding the problem set forth above, the non-patent document set forth above discloses a pipeline device consisting of an image-processing processor, a binarize processor, and a histogram processor connected in series in this order.

The pipeline device works to disable the functions of at least one of the processors so as to implement:

the combination of the functions of the image-processing processor and those of the histogram processor;

the combination of the functions of the image-processing processor and those of the binarize processor; and

the combination of the functions of the binarize processor and those of the histogram processor.

However, the disabling of the functions of part of the pipeline device does not effectively share the processors, and therefore, it is difficult to carry out a plurality of image-processing tasks with a single hardware device.

Specifically, as described above, the preprocessing task of a gradient method for optical-flow estimation, the edge-detection task, and the preprocessing task of labeling can be carried out by common processing units. However, in order to carry out each of the preprocessing task of a gradient method for optical-flow estimation, the edge-detection task, and the preprocessing task of labeling, other processing units that are unnecessary for another one of the tasks must be required. In addition, the common processing units and the other processing units are required to be used in the different orders for the respective tasks (see FIGS. 16A to 16D described hereinafter).

Thus, the disabling of the functions of part of an image processing device for carrying out the preprocessing task of a gradient method for optical-flow estimation, the edge-detection task, and the preprocessing task of labeling does not effectively share the common processing units and the other processing units of the image processing device. It is therefore difficult to perform the preprocessing task of a gradient method for optical-flow estimation, the edge-detection task, and the preprocessing task of labeling with a single hardware device.

### SUMMARY OF THE INVENTION

In view of the background, an object of at least one aspect of the present invention is to provide pipeline devices each with a plurality of processing units (stages) for carrying out a process in pipeline; these pipeline devices are each capable of effectively sharing the plurality of processing units so as to carry out various data-processing tasks, such as various image-processing tasks, without using a plurality of hardware devices.

In addition, another object of at least one aspect of the present invention is to provide data processing apparatus each installed with such a pipeline device.

According to one aspect of the present invention, there is provided a pipeline device. The pipeline device includes a plurality of data transfer lines including: a data input line through which data is inputted, and a plurality of data output lines. The pipeline device includes a plurality of processing units each having an input and an output. The output of each of the plurality of processing units is connected to a corresponding one of the data output lines. The pipeline device includes a plurality of input selectors provided for the plurality of processing units, respectively. Each of the plurality of input selectors works to select one of the plurality of data transfer lines except for one data output line to which the output of a corresponding one of the plurality of processing units is connected to thereby determine one of a plurality of interconnection patterns among the plurality of processing units. The plurality of interconnection patterns correspond to a plurality of data-processing tasks, respectively. Each of the plurality of input selectors works to input, to a corresponding one of the plurality of processing units via the input thereof, data flowing through the selected one of the plurality of data transfer lines. Each of the plurality of processing units works to individually carrying out a predetermined process based on data inputted hereto by a corresponding one of the plurality of input selectors to thereby carry out, in pipeline, one of the plurality of data-processing tasks corresponding to the determined one of the plurality of interconnection patterns.

According to another aspect of the present invention, there is provided a data-processing apparatus. The data-processing apparatus includes a plurality of data transfer lines including a data input line trough which data is inputted, and a plurality of data output lines. The data-processing apparatus includes a plurality of processing units each having an input and an output. The output of each of the plurality of processing units is connected to a corresponding one of the data output lines. The data-processing apparatus includes a plurality of input selectors provided for the plurality of processing units, respectively. The data-processing apparatus includes a controller working to input, to the plurality of input selectors, a control signal representing one of a plurality of interconnection patterns among the plurality of processing units. The plurality of interconnection patterns correspond to a plurality of data-processing tasks, respectively. Each of the plurality of input selectors works to select one of the plurality of data transfer lines except for one data output line to which the output of a corresponding one of the plurality of processing units is connected to thereby determine one of the plurality of interconnection patterns among the plurality of processing its. Each of the plurality of input selectors works to input, to a corresponding one of the plurality of processing units via the input thereof, data flowing through the selected one of the plurality of data transfer lines. Each of the plurality of processing units works to individually carry out a predetermined process based on data inputted thereto by a corresponding one of the plurality of input selectors to thereby carry out, in pipeline, one of the plurality of data-processing tasks corresponding to the determined one of the plurality of interconnection patterns.

### BRIEF DESCRIPTION OF THE DRAWINGS

Other objects and aspects of the invention will become apparent from the following description of embodiments with reference to the accompanying drawings in which:

FIG. 1 is a block diagram schematically illustrating an example of the structure of an information processing device according to a first embodiment of the present invention;

FIG. 2 is a timing chart schematically illustrating output signals from a video input unit illustrated in FIG. 1 according to the first embodiment;

FIG. 3 is a circuit diagram schematically illustrating an example of the hardware structure of an image processor illustrated in FIG. 1 according to the first embodiment;

FIG. 4A is a circuit diagram schematically illustrating an example of the hardware structure of a convolution unit according to the first embodiment;

FIG. 4B is a block diagram schematically illustrating an example of the hardware structure of a gradation conversion unit according to the first embodiment;

FIG. 4C is a block diagram schematically illustrating an example of the hardware structure of a dilation unit according to the first embodiment;

FIG. 4D is a block diagram schematically illustrating an example of the hardware structure of an erosion unit according to the first embodiment;

FIG. 5 is a circuit diagram schematically illustrating part of the convolution unit according to the first embodiment;

FIG. 6 is a timing chart schematically illustrating temporal relationships among a data input task, a multiplying task, a summing task, and an outputting task according to the first embodiment;

FIG. 7A is a block diagram schematically illustrating a first interconnection pattern in that first, second, third, and fourth processing units illustrated in FIG. 1 are connected in series in this order according to the first embodiment;

FIG. 7B is a block diagram schematically illustrating a second interconnection pattern in that some of the first, second, third, and fourth processing units are connected in series in this order according to the first embodiment;

FIG. 7C is a block diagram schematically illustrating a third interconnection patter in that the first, second, third, and fourth processing units are parallely connected according to the first embodiment.

FIG. 7D is a block diagram schematically illustrating a fourth on topology pattern in that the first second, third, and fourth processing units are connected in series in this order according to the first embodiment;

FIG. 8 is a circuit diagram schematically illustrating an example of the hardware structure of an enable signal input unit of an image-processing controller illustrated in FIG. 1 according to the first embodiment;

FIG. 9 is a timing chart schematically illustrating temporal relationships among enable signals outputted from first to fourth stages of the image processor illustrated in FIG. 3 according to the first embodiment;

FIG. 10A is a block diagram schematically demonstrates an interrupt request to be inputted from an interrupt input it of the image-processing controller to a microcomputer of the information processing device according to the first embodiment;

FIG. 10B is a timing chart schematically demonstrating an input timing of an interrupt request to the microcomputer from the interrupt input unit according to the first embodiment;

FIG. 11 is a circuit diagram schematically illustrating an example of the hardware structure of an enable signal input unit according to a second embodiment of the present invention;

FIG. 12 is a circuit diagram schematically illustrating an example of the hardware structure of an image processor according to a third embodiment of the present invention;

FIG. 13 is an explanation drawing schematically illustrating an example of how to obtain a result Ps [x, y] of a 5×5 matrix convolution using the first to fourth processing units each with a 3×3 kernel matrix according to the third embodiment;

FIG. 14 is a circuit diagram schematically illustrating an example of the hardware structure of an enable signal input unit according to the third embodiment;

FIG. 15 is a circuit diagram schematically illustrating an example of the hardware structure of an image processor according to a fourth embodiment of the present invention;

FIG. 16A is a block diagram schematically illustrating one of interconnection patterns among the first to fourth processing its illustrated in FIG. 15 for a preprocessing task of a gradient method for optical-flow estimation according to the fourth embodiment;

FIG. 16B is a block diagram schematically illustrating a first alternative one of interconnection patterns among the first to fourth processing units illustrated in FIG. 15 for an edge-detection task according to the fourth embodiment;

FIG. 16C is a block diagram schematically illustrating a second alternative one of interconnection patterns among the first to fourth processing units illustrated in FIG. 15 for a preprocessing task of labeling according to the fourth embodiment;

FIG. 16D is a block diagram schematically illustrating a third alternative one of interconnection patterns among the first to fourth processing units illustrated in FIG. 15 for a filtering task with a 5×5 kernel coefficient matrix according to the fourth embodiment;

FIG. 17 is a flowchart schematically illustrating an optical flow estimating routine to be carried out by tie microcomputer according to the fourth embodiment;

FIG. 18 is a flowchart schematically illustrating an edge-enhanced image generating routine to be carried out by the microcomputer according to the fourth embodiment;

FIG. 19 is a flowchart schematically illustrating a smoothed image generating routine to be carried out by the microcomputer according to the fourth embodiment;

FIG. 20A is a flowchart schematically illustrating the flow of input data transferring as output data through a convolution unit; and

FIG. 20B is a view schematically illustrating a conventional method of generating a smoothed image using tie convolution unit.

### DETAILED DESCRIPTION OF EMBODIMENTS OF THE INVENTION

Embodiments of the present invention will be described hereinafter with reference to the accompanying drawings.

### First Embodiment

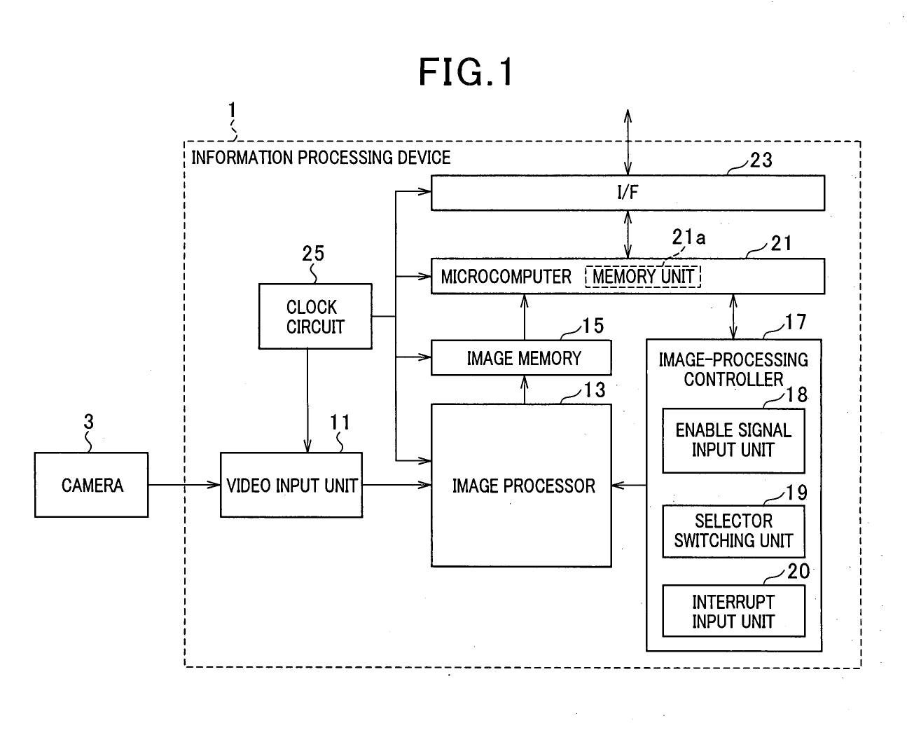

Referring to FIG. 1, there is provided an information processing device 1 as an example of data processing apparatus according to a first embodiment of the present invention.

The information processing device 1 is equipped with a video input unit 1 communicably coupled to an external camera 3, an image processor 13, an image memory 15, an image-processing controller 17, a microcomputer 21, an input/output (I/O) interface 23, and a clock circuit 25.

For example, the camera 3 works to pick up or receive a plurality of x-y dimensional frame images of a target, and to input, to the video input with 11, the plurality of frame images with a frame synchronizing signal FS and a line synchronizing signal LS as composite video signals. Each of the frame images consists of, for example, a predetermined number of lines of pixels.

The frame synchronizing signal FS is a pulse signal consisting of a series of pulses each varying from a base level corresponding to a logical “0” to a high level corresponding to a logical “1”. The rising edge of each pulse in the frame synchronizing signal represents the beginning of a corresponding one frame image, and the trailing edge of each pulse therein represents the end thereof.

The line synchronizing signal LS is a pulse signal consisting of a series of pulses each varying from a base level corresponding to a logical “0” to a high level corresponding to a logical “1”. The rising edge of each pulse in the line synchronizing signal represents the beginning of a corresponding one line of one frame image, and the trailing edge of each pulse therein represents the end thereof.

The vide input unit 11 is connected to the image processor 13 and the image-processing controller 17, and operative to receive the composite video signals inputted from the camera 3.

The video input unit 11 is also operative to separate the frame synchronizing signal FS and line synchronizing signal LS from the composite video signals, convert the video signals into digital video data, and input, to the image processor 13, the generated digital video data as serial data.

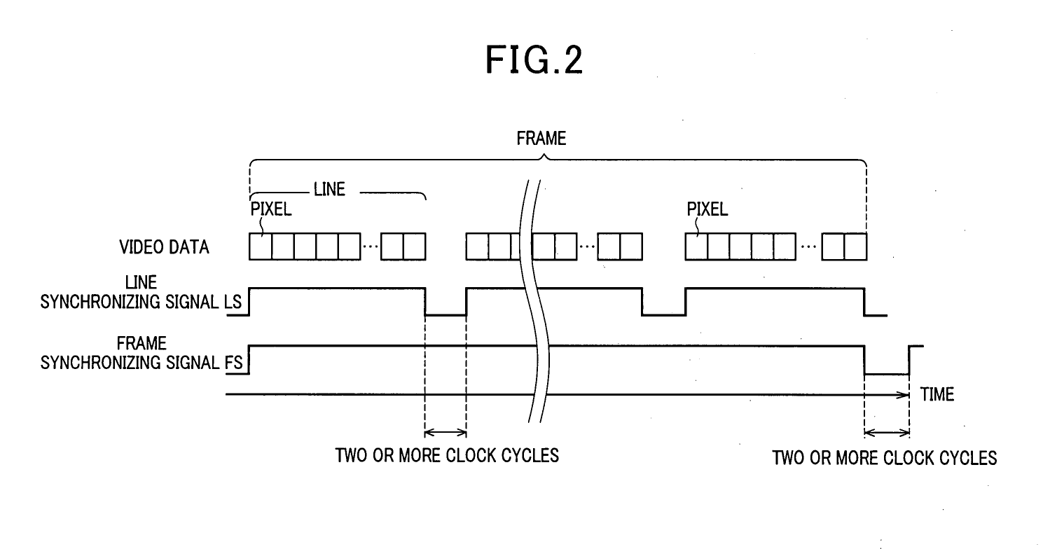

Specifically, referring to FIG. 2, the video input unit 11 sends, to the image processor 13, the digital video data horizontal-line by horizontal-line of each of the frame images from, for example, the upper side to the lower side.

In other words, the video input unit 11 serially transmits, to the image processor 13, horizontal-line data bit by bit from the leftmost pixel to the rightmost pixel; this horizontal-line data consists of pixels of one horizontal line of one frame image

Each pixel of one horizontal line consists of one or more bits of information (bit value), representing the brightness (light intensity) of a corresponding location of the corresponding one horizontal line. The bit value of one pixel of one horizontal line of one frame image will be also referred to as “pixel data” hereinafter.

The video input unit 11 also sends, to the image-processing controller 17, the separated frame synchronizing signal FS and line synchronizing signal LS for each of the frame images.

The image processor 13 or a combination of the image processor 13 and at least part of the image-processing controller 18 serve as an example of pipeline devices according to the first embodiment of the present invention. Specifically, the image processor 13 is connected to the image memory 15 and the image-processing controller 17, and made up of a plurality of processing units (stages), such as four processing units 31a, 31b, 31c, and 31d. The image processor 13 is designed to receive the digital video data of each of the frame images, and carry out, based on the received digital video data of each of the frame images, at least one of various image-processing tasks in pipeline. The digital video data of one frame image will be referred to as “frame video data” hereinafter.

The image processor 13 is also designed to store, in the image memory 15, pieces of the frame video data that have been subjected to at least one of the various image-processing tasks.

The image-processing controller 17 is connected to the microcomputer 21.

The image-processing controller 17 is operative to:

receive the fame synchronizing signal FS and line synchronizing signal LS for each of the frame images sent from the video input unit 11; and

output, in accordance with commands sent from the microcomputer 21, control signals to the image processor 13 based on the received fame synchronizing signal FS and line synchronizing signal LS for each of the frame images.

Specifically, referring to FIG. 1, the image-processing controller 17 is provided with an enable signal input unit 18, a selector switching unit 19, and an interrupt input unit 20.

The enable signal input unit 18 works to generate enable signals based on the frame synchronizing signal FS and line synchronizing signal LS for each of the frame images. The enable signal input unit 18 also works to input the generated enable signals to each of the processing units 31a, 31b, 31c, and 31d of the image processor 13.

Specifically, the logical conditions of the enable signals to be inputted to each of the processing units 31a to 31d can enable or disable input of pixel data of the frame video data from the video input unit 11 to a corresponding one of the processing units 31a to 31d. The operations of the enable signal input unit 18 will be described hereinafter.

The selector switching unit 19 works to control input selectors and an output selector installed in the image processor 13 described hereinafter to thereby switch a route of frame video data to be transferred through at least one of the processing units 31a, 31b, 31c, and 31d. Specifically, the operations of the selector switching unit 19 allow determination of one of the interconnections (interconnection topology) among the processing units 31a, 31b, 31c, and 31d, thus carrying out the various image-processing tasks in pipeline.

The interrupt input unit 20 works to input, to the microcomputer 21, an interrupt request based on the enable signals generated by the enable signal input unit 18. Specifically, the interrupt input unit 20 works to input to the microcomputer 21, an interrupt request every time at least one of the various image processing tasks for one frame image is completed so that the digital video data corresponding thereto is stored in the image memory 15. The interrupt request allows the microcomputer 21 to grasp that at least one of the various image processing tasks for one frame image is completed.

The microcomputer 21 includes a memory unit 21a in which at least one program is stored in advance. In accordance with the at least one program stored in the memory unit 21a, the microcomputer 21 controls overall operations of the information processing device 1.

Specifically, the microcomputer 21 is programmed to input, to the image-processing controller 17, a command to switch the operation mode of the image processor 13 to thereby switch the operation mode of the image processor 13 via the image-processing controller 17.

The microcomputer 21 is also programmed to read frame video data corresponding to at least one desired frame image. The microcomputer 21 is further programmed to subject the readout frame video data to at least one image-processing task as need arises, and output, to an external device through the I/O interface 23, the frame video data that has been subjected to the at least one image-processing task.

For example, the microcomputer 21 converts the readout frame video data corresponding to at least one desired frame image into an analog frame image, and displays, via the I/O interface 23, the analog frame image on the screen of a display device (not shown) as an example of the external devices. This allows the information processing device 1 to display frame images picked-up by the camera 3 on the screen of the display device.

The clock circuit 25 is connected to each of the video input unit 11, the image processor 13, the image memory 15, the image-processing controller 17, the microcomputer 21, and the I/O interface 23. The clock circuit 25 works to generate a clock signal consisting of clock pulses with a constant clock cycle, and to supply the generated clock signal to, for example, each of the components 11, 13, 15, 17, 21, and 23.

The hardware structure of the image processor 13 is changed depending on the various image-processing tasks to be carried out thereby.

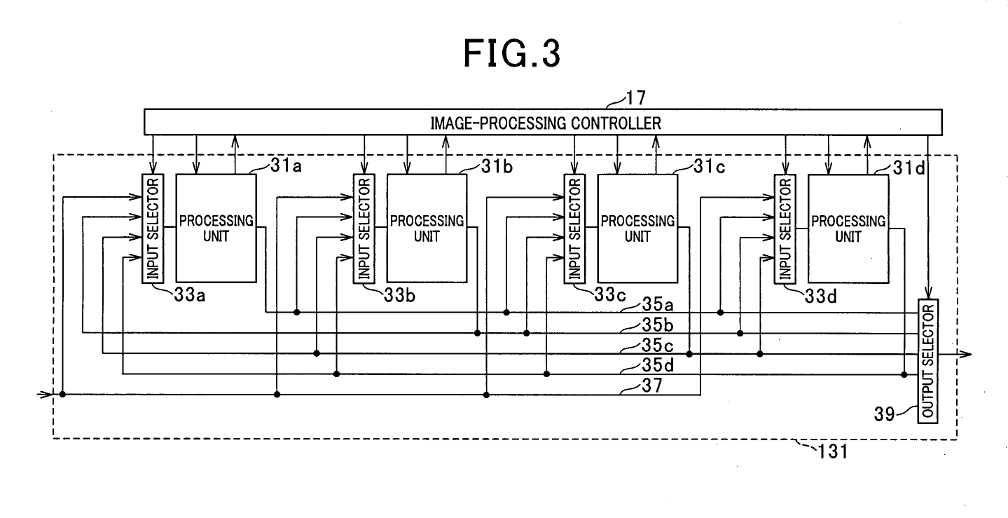

The hardware structure of the image processor 13 operable in a first basic processing mode according to the first embodiment, which is illustrated as an image processor 131 in FIG. 3, will be described hereinafter.

The image processor 131 according to the first embodiment is equipped with a first processing unit 31a, a second processing unit 31b, a third processing unit 31c, and a fourth processing unit 31d.

The image processor 131 is also equipped with a first data input selector 33a , a second data input selector 33b, a third data input selector 33c, and a fourth data input selector 33d provided for the first processing unit 31a, the second processing it 31b, the third processing unit 31c, and the fourth processing unit 31d, respectively.

The image processor 131 is further equipped with an output selector 39.

In the first operation mode of the image processor 131, any one of a convolution unit 40, a gradation conversion unit 40A, a dilation unit 40B, and an erosion unit 40C is installed in each of the first, second, third, and fourth processing units 31a, 31b, 31c, and 31d.

The gradation conversion unit 40A is designed to convert the bit value (intensity level) of each pixel of frame video data inputted thereto into an alternative bit value to thereby change the gradation of the frame video data into an alternative gradation thereof.

For example, the gradation conversion unit 40A is integrated with an intensity-level conversion table T1. The intensity-level conversion table T1 consists of a predetermined bit value corresponding to a predetermined alternative intensity level for each pixel of frame video data inputted to the gradation conversion unit 40A. Based on the intensity-level conversion table T1, the gradation conversion unit 40A transforms the bit value (intensity level) of each pixel of frame video data inputted thereto to a predetermined alternative bit value (intensity level) stored in the intensity-level conversion table T1 to be associated with a corresponding one pixel.

The image processor 131 integrated with the gradation conversion unit 40A can adjust the bit value (intensity level) of the alternative intensity level stored in the intensity-level conversion table T1 to be associated with each pixel of frame video data inputted to the gradation transmission unit 40A to thereby carry out a plurality of image-processing tasks. The plurality of image-processing tasks to be carried out by the gradation transformation unit 40A include an intensity-level reversal task, a binarizing task, a contrast task, and the like.

The intensity-level reversal task, such as a negative-positive reversal task, is, for example, to convert:

a bit value (intensity level) of at least one pixel of frame video data inputted to the unit 40A, which is equal to or higher than a predetermined threshold value, into a predetermined bit value lower than the threshold value; and

a bit value (intensity level) of at least one pixel of frame video data inputted to the unit 40A, which is lower than the threshold value, into a predetermined bit value higher than the threshold value.

The binarizing task is, for example, to convert:

a bit value (intensity level) of at least one pixel of frame video data inputted to the unit 31b, which is equal to or higher than a predetermined threshold value, into a bit value of “1”; and

a bit value (intensity level) of at least one pixel of frame video data inputted to the unit 40A, which is lower than the threshold value, into a bit value of “0”.

The contrast task is, for example, to convert a bit value (intensity level) of each pixel of frame video data inputted to the unit 40A into a predetermined bit value in accordance with a predetermined contrast curve previously determined for each pixel.

The dilation unit 40B is designed to, for example, OR bit values of pixels around a specified pixel of frame video data inputted thereto to thereby complement data of the specified pixel; this specified pixel of one frame image represents a light-intensity missing part in an area or line of the corresponding one frame image.

The eroding unit 40C is designed to, for example, AND bit values of pixels around a specified pixel of one frame image inputted thereto to thereby delete data of the specified pixel; this specified pixel of one frame image represents orphan data, such as noise.

The convolution unit 40 is designed to perform a convolution task by multiplying, by a predetermined kernel coefficient matrix H, the bit value of each pixel in one frame image inputted thereto (m is an integer not less than 2). For example, in the first embodiment, the convolution unit 40 has a 3×3 pixel matrix (kernel coefficient matrix, m is set to be “3”).

After completion of the convolution task, the convolution unit 40 is designed to output the sum of the bit values of the pixels in the 3×3 block as a bit value of a center pixel of the 3×3 block in the output frame video data that has been subjected to the convolution task.

The convolution task of the convolution unit 40 based on frame video data inputted thereto can generate smoothed image data and gradient image data.

Each of the first to fourth processing units 31a to 31d integrated with any one of the image-processing units 40, 40A, 40B, and 40C is designed to individually:

perform a corresponding image-processing task based on frame video data inputted thereto; and

output a result of the corresponding image-processing task.

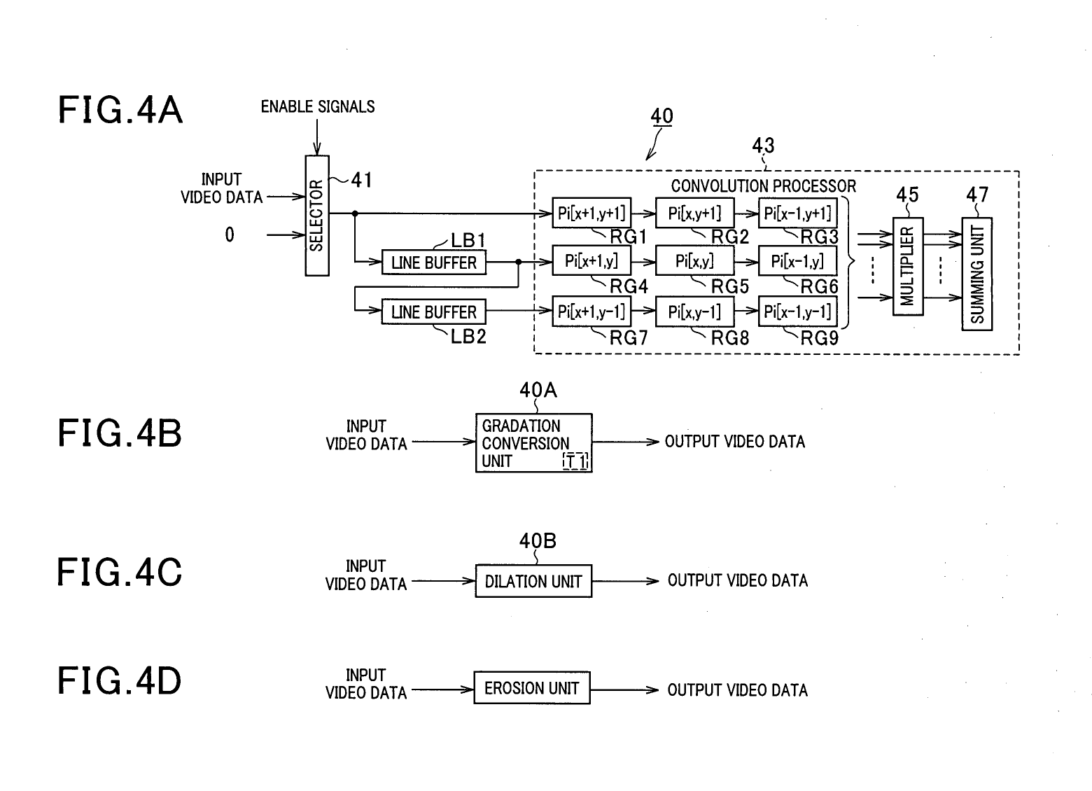

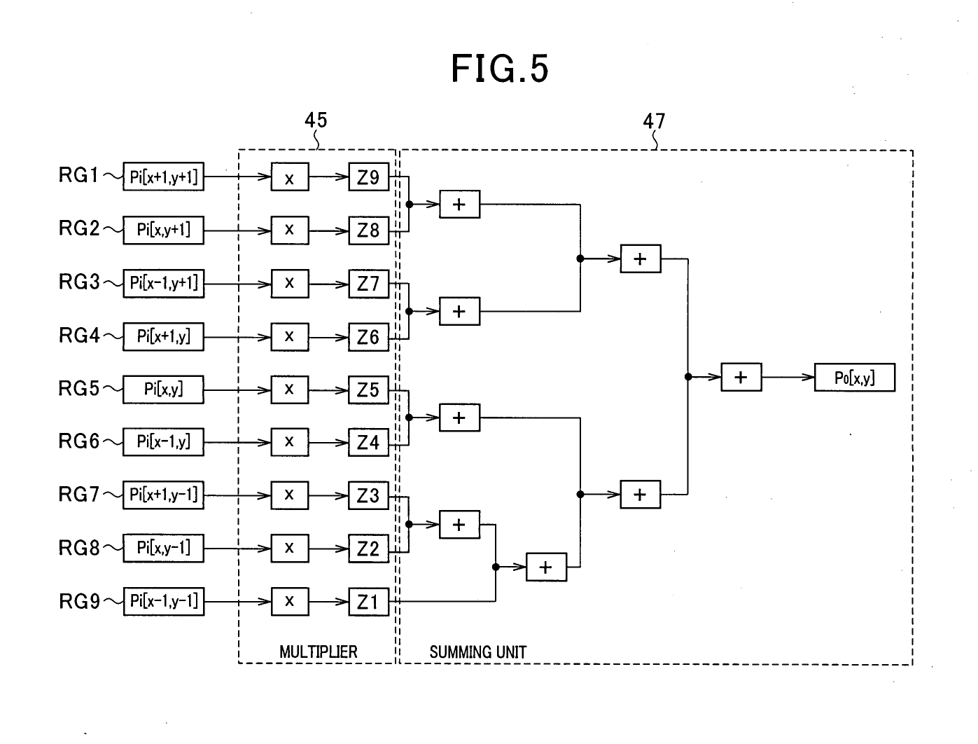

An example of the hardware structure of the convolution unit 40 with the kernel matrix of 3 rows and 3 columns will be described hereinafter with reference to FIGS. 4 and 5.

The convolution unit 40 consists of a selector 41, a convolution processor 43, and first and second line buffers LB1 and LB2. The convolution processor 43 is integrated with first to ninth registers RG1 to RG9 for storing therein the bit values of the 3×3 pixel matrix in frame video data inputted thereto.

The selector 41 has an input connected to a data input selector, and an output connected to the first register RG1 of the convolution processor 43. The selector 41 works to receive, from the data input selector connected to the input thereof, frame video data and to transfer, pixel by pixel, the received frame video data to the convolution processor 43 each clock cycle of the clock signal.

Specifically, the selector 41 works to transfer, pixel by pixel, the received frame video data to the first register RG1 of the convolution processor 43 via each clock cycle of the clock signal only when both the enable signals are in the logical “1”.

This allows the pixel data of the frame video data to be stored pixel by pixel in the first register RG1 each clock cycle of the clock signal.

Otherwise, when at least one of the enable signals is in the logical “0”, the selector 41 works to transfer a bit value of “0” to the first register RG1 of the convolution processor 43 each clock cycle of the clock signal.

This allows the bit value of “0” to be stored pixel by pixel in the first register RG1 each clock cycle of the clock signal.

The serially connected first to third registers RG1 to RG3 serve as shift registers.

Specifically, each clock cycle of the clock signal, the first register RG1 works to receive and store pixel data sent from the selector 41 while transferring previous pixel data stored therein to the second register RG2. Each clock cycle of the clock signal, the second register RG2 works to receive and store pixel data sent from the first register RG1 while transferring previous pixel data stored therein to the third register RG3.

Each clock cycle of the clock signal, the third register RG3 works to receive and store pixel data sent from the second register RG2.

Specifically, pixel data stored in the first register RG1 is shifted to the second register RG2 upon application of one clock pulse of the clock signal, and the pixel data stored in the second register RG2 is shifted to the third register RG3 upon application of the next clock pulse of the clock signal.

Similarly, the fourth to sixth registers RG4 to RG6 are connected in series in this order to serve as shift registers, and the seventh to ninth registers RG7 to RG9 are connected in series in this order to serve as shift registers.

Each of the first and second line buffers LB1 and LB2 has an input and an output. Each of the first and second line buffers LB1 and LB2 is designed as an FIFO (First in First out) line buffer and configured to store therein the bit values of pixels of one horizontal line of frame video data inputted thereto.

Specifically, the input of the fist line buffer LB1 is connected to the output of the selector 41, and the output of the first line buffer LB1 is connected to both the input of the line buffer LB2 and the fourth register RG4.

The first line buffer LB1 works to receive and store pixel data sent from the selector 41 each clock cycle of the clock signal, and, after becoming filly, the first line buffer LB1 works to transfer, to the fourth register RG4 pixel data stored therein in the order from the firstly received bit to the lastly received bit.

Specifically, pixel data of one horizontal line in the frame video data is transferred to the first register RG1, and transferred to the fourth register RG4 via the first line buffer LB1 to be delayed relative to the transfer of the pixel data to the first register RG1 by a first delay period. The same pixel data of the same one horizontal line in the frame video data is also transferred to the seventh register RG7 via the second line buffer LB2 to be delayed relative to the transfer of the pixel data to the first register RG1 by a second delay period. The first delay period is a period required to completely transfer the pixel data of one horizontal line in the frame video data from the selector 41 to the first register RG1. The second delay period is a period required to completely transfer the pixel data of one horizontal line in the frame video data to each of the first register RG1 and the second register RG2.

As well as the first to third shift registers RG1 to RG3, pixel data received to be stored in the fourth register RG4 is shifted to the fifth register RG5 upon application of one clock pulse of the clock signal, and the pixel data stored in the fifth register RG5 is shifted to the sixth register RG6 upon application of the next clock pulse of the clock signal.

Similarly, pixel data received to be stored in the seventh register RG7 is shifted to the eighth register RG8 upon application of one clock pulse of the clock signal, and the pixel data stored in the eighth register RG8 is shifted to the ninth register RG9 upon application of the next clock pulse of the clock signal.

More specifically, when pixel data Pi [x+1, y+1] in the frame video data at the coordinate point (x+1, y+1) is stored in the first register RG1, pixel data Pi [x, y+1] in the frame video data at the coordinate point (x, y+1) is stored in the second register RG2, and pixel data Pi [x−1, y+1] in the frame video data at the coordinate point (x−1, y+1) is stored in the third register RG3.

Additionally, when pixel data Pi [x+1, y] in the frame video data at the coordinate point (x+1, y) is stored in the forth register RG4, pixel data Pi [x, y] in the frame video data at the coordinate point (x, y) is stored in the fifth register RG5, and pixel data Pi [x−1, y] in the frame video data at the coordinate point (x−1, y) is stored in the sixth register RG6.

Similarly, when pixel data Pi [x+1, y−1] in the frame video data at the coordinate point (x+1, y−1) is stored in the seventh register RG7, pixel data Pi [x, y−1] in the frame video data at the coordinate point (x, y−1) is stored in the eighth register RG8, and pixel data Pi [x−1, y−1] in the frame video data at the coordinate point (x−1, y−1) is stored in the ninth register RG9.

Referring to FIGS. 4A and 5, the convolution processor 43 is also equipped with a multiplier 45 and a summing unit 47 after the first to ninth registers RG1 to RG9. The convolution processor 43, the multiplier 45, and the summing unit 47 are arranged in a sequence such that an output of each of the first to ninth registers RG1 to RG9 is connected to the multiplier 45, and an output of the multiplier 45 is connected to the summing unit 47. The multiplier 45 and the summing unit 47 are configured to perform a multiplying task and a total sum calculating task in pipeline based on the pixel data stored in each of the first to ninth registers RG1 to RG9.

In the convolution processor 43, the multiplier 45 works to carry out the multiplying task based on the pixel data stored in each of the first to ninth registers RG1 to RG9, and the summing unit 47 works to carry out the total sum calculating task by summing values obtained by the multiplier 45.

Specifically, in accordance with the following equations, the multiplier 45 is configured to calculate values Z1 to Z9 based on the pixel data stored in each of the first to ninth registers RG1 to RG9 and a 3×3 kernel coefficient matrix H that consists of “h [−1, −1], . . . , h [0, 0], . . . , and h [1, 1]”:

Z1=Pi [x−1, y−1]·h [−1, −1]

Z2=Pi [x, y−1]·h [0, −1]

Z3=Pi [x+1, y−1]·h [1, −1]

Z4=Pi [x−1, y]·h [−1, 0]

Z5=Pi [x, y]·h [0, 0]

Z6=Pi [x+1, y]·h [1, 0]

Z7=Pi [x−1, y+1]·h [−1, 1]

Z8=Pi [x, y+1]·h [0, 1]

Z9=Pi [x+1, y+1]·h [1, 1]

The summing unit 47 works to calculate a total sum as pixel data Po [x, y] of output video data from the convolution processor 43 at the coordinate point (x, y) in accordance with the following equation:

Po [x, y]=Z1+Z2+Z3+Z4+Z5+Z6+Z7+Z8+Z9

Specifically, the convolution unit 40 is configured to:

receive the pixel data Pi [x, y] in the input video data at the coordinate point (x, y); and

carry out the convolution task in pipeline based on the received pixel data Fi [x, y] in the input video data to thereby output pixel data Po [x, y] in output video data at the coordinate point (x, y) as the result of the convolution task.

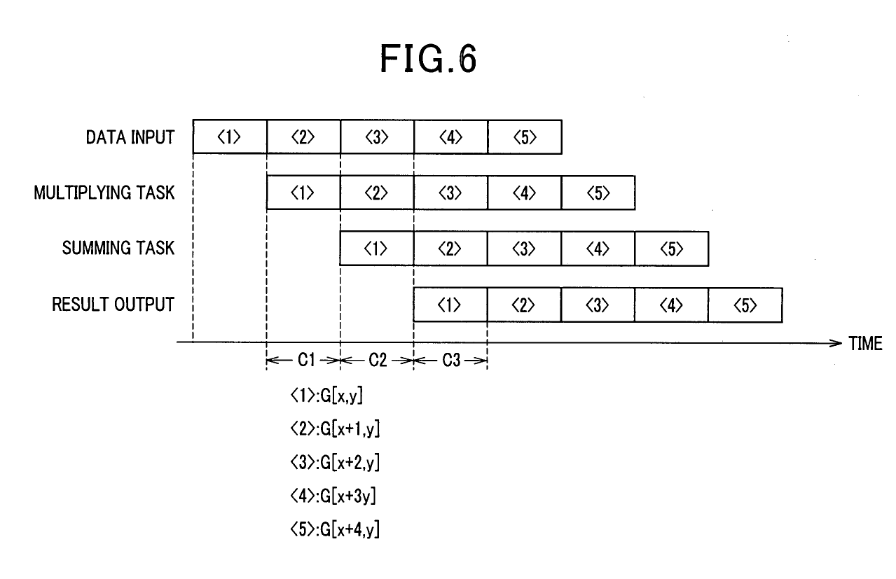

FIG. 6 schematically shows the operation stages of the convolution unit 40 in time.

Specifically, in tie convolution unit 40, the pixel data Pi [x−1, y−1], Pi [x: y−1], Pi [x+1, y−1], Pi [x−1, y], Pi [x, y], Pi [x+1, y], Pi [x−1, y+1], Pi [x, y+1] and Pi [x+1, y+1] contained in a 3×3 pixel matrix G [x, y] in the input frame video data are inputted to the first register RG1, second register RG2, third register RG3, fourth register RG4, fifth register RG5, sixth register RG6, seventh register RG7, eighth register RG8, and ninth register RG9, respectively.

Thereafter, the multiplying task of the multiplier 45 is carried out based on the pixel data Pi [x−1, y−1], Pi [x, y−1], Pi [x+1, y−1], Pi [x−1, y], Pi [x, y], Pi [x+1, y], Pi [x−1, y+1], Pi [x, y+1], and Pi [x+1, y+1) in one clock cycle C1 of the clock signal after the pixel data have been stored in the first to ninth registers RG1 to RG9. This allows the values Z1 to Z9 for the 3×3 block G [x, y] to be obtained.

In the one clock cycle C1 of the clock signal, the pixel data contained in a 3×3 pixel matrix G [x+1, y] in the input frame video data are parallely inputted to the first register RG1, second register RG2, third register RG3, fourth register RG4, fifth register RG5, sixth register RG6, seventh register RG7, eighth register RG8, and ninth register RG9, respectively.

In the next clock cycle C2 of the clock signal, the summing task of the summing unit 47 is carried out based on the values Z1 to Z9 for the 3×3 block G [x, y] so that the output pixel data Po [x, y] in the output video data at the coordinate point (x, y) is obtained.

In the clock cycle C2 of the clock signal, the multiplying task of the multiplier 45 is parallely carried out based on the pixel data contained in the 3×3 block G [x+1, y] stored in the first to ninth registers RG1 to RG9. This allows the values Z1 to Z9 for the 3×3 block G [x+1, y] to be obtained.

In the clock cycle C2 of the clock signal, the pixel data contained in a 3×3 block G [x+2, y] of pixels in the input frame video data are parallely inputted to the first register RG1, second register RG2, third register RG3, fourth register RG4, fifth register RG5, sixth register RG6, seventh register RG7, eighth register RG8, and ninth register RG9, respectively.

In the next clock cycle C3 of the clock signal, the output pixel data Po [x, y] in the output video data at the coordinate point (x, y) is transferred to, for example, the image memory 15 from the convolution unit 40 as the result of the convolution task.

In the clock cycle C3 of the clock signal, the summing task of the summing unit 47 is carried out based on the values Z1 to Z9 for the 3×3 block G [x+1, y] so that the output pixel data Po [x+1, y] in the output video data at the coordinate point (x1, y) is obtained.

In the clock cycle CS of the clock signal, the multiplying task of the multiplier 45 is parallely cared out based on the pixel data contained in the 3×3 block G [x+2, y] stored in the first to ninth registers RG1 to RG9. This allows the values Z1 to Z9 for the 3×3 block G [x+2, y] to be obtained.

In the clock cycle C3 of the clock signal, the pixel data contained in a 3×3 block G [x+3, y] of pixels in the input frame video data are parallely inputted to the first register RG1, second register RG2, third register RG3, fourth register RG4, fifth register RG5, sixth register RG6, seventh register RG7, eighth register RG8, and ninth register RG9, respectively.

In the first embodiment, the video input unit 11 is configured to send, to the image processor 13, pieces of the horizontal-line data of one frame image at intervals of two or more clock cycles of the clock signal (see FIG. 2). In other words, the line synchronizing signal LS is in the logical “0” during no line data being sent from the video input unit 11 to the image processor 13.

For examples when the line synchronizing signal LS is input to the selector 41 as one of the enable signals, the selector 41 works to output a bit value of “0” while the pixel data for one horizontal line of the frame video data is switched to that of the next horizontal line thereof. This allows the data stored in each of the first to ninth registers RG1 to RG9 to be cleared to zero until the pixel data of the next horizontal line reaches the convolution processor 43.

Additionally, the video input unit 11 is configured to send, to the image processor 13, pieces of the frame video data of the picked-up frame images at intervals of two or more clock cycles of the clock signal (see FIG. 2). In other words, the frame synchronizing signal FS is in the logical “0” during no frame video data being sent from the video input unit 11 to the image processor 13.

For example, when the frame synchronizing signal FS is input to the selector 41 as one of the enable signals, the selector 41 works to output a bit value of “0” while the frame video data of one frame image is switched to that of the next frame image. This allows the number of bit values of “0” depending on the intervals between the pieces of the frame video data to be stored in each of the first and second line buffers LB1 and LB2.

The configuration of the video input unit 11 and tie selector 41 allows the convolution task to be individually carried out for each of the pieces of frame image data (each of the frame images).

Returning to FIG. 3, in the image processor 131 according to the first embodiment, each of the first to fourth processing units 31a to 31d is integrated with the convolution unit 40. In other words, the image processor 131 is provided with the first to fourth stages 31a to 31d of convolution.

In addition, the first, second, third, and fourth data input selectors 33a, 33b, 33c, and 33d are located prior to the first, second, third, and fourth processing its 31a, 31b, 31c, and 31d, respectively.

Specifically, each of the first to fourth processing units 31a to 31d has an input connected to an output of a corresponding one of the first to fourth data input selectors 33a to 33d. This allows each of the first to fourth data input selectors 33a to 33d to input frame video data to a corresponding one of the first to fourth processing units 31a to 31d.

Each of the first to fourth processing units 31a to 31d has a first output connected to a corresponding one of data output lines 35a to 35d. Reference character 37 represents a data input line connected to the video input unit 11 to allow the pieces of the frame video data to be input to the image processor 131.

Each of the first to forth data input selectors 33a to 33d has four inputs connected to the data input line 37 and the data output lines 35a to 35d except for the one data output line connected to the first output of a corresponding one processing unit

Specifically, the first data input selector 33a is connected at its an input to the data output line 35b connected to the first output of the second processing unit 31b. The first data input selector 33a is also connected at its inputs to the data output line 35c connected to the first output of the third processing unit 31c, the data output line 35d connected to the first output of the fourth processing unit 31d, and the data input line 37. The first data input selector 33a is also connected at its output to the input of the first processing unit 31a.

The second data input selector 33b is connected at its an input to the data output line 35a connected to the first output of the first processing unit 31a. The second data input selector 33b is also connected at its inputs to the data output line 35c connected to the first output of the third processing unit 31c, the data output line 35d connected to the first output of the fourth processing unit 31d, and the data input line 37. The second data input selector 33b is also connected at its output to the input of the second processing unit 31b.

The third data input selector 33c is connected at its an input to the data output line 35a connected to the first output of the first processing unit 31a. The third data input selector 33c is also connected to the data output line 35b connected to the first output of the second processing unit 31b, the data output line 35d connected to the first output of the fourth processing unit 31d, and the data input he 37. The third data input selector 33c is also connected at its output to the input of the third processing unit 31c.

The fourth data input selector 33d is connected at its an input to the data output line 35a connected to the first output of the first processing unit 31a. The fourth data input selector 33d is connected at its inputs to the data output line 35b connected to the first output of the second processing unit 31b, the data output line 35c connected to the first output of the third processing unit 31c, and the data input line 37, The fourth data input selector 33d is also connected at its output to the input of the fourth processing unit 31d.

Each of the first to fourth data input selectors 33a to 33d is connected at its control terminal to the image-processing controller 17. In accordance with the control signals inputted from the selector switching unit 19 of the controller 17, each of the first to fourth data input selectors 33a to 33d works to select one of the plurality of data transfer lines (the corresponding data output lines and data input line 37). In addition, each of the first to fourth data input selectors 33a to 33d works to input, to the corresponding one of the processing units 31a to 31d, frame video data flowing through the selected one of the plurality of data transfer lines.

Each of the processing units 31a to 31d works to receive the frame video data inputted from the corresponding data input selector, and to carry out, based on the received frame video data, the corresponding image-processing task, such as the convolution task when the convolution unit 40 is installed in each of the processing units 31a to 31d. Each of the processing units 31a to 31d also works to transfer, through the corresponding data output line connected to its first output, output data representing the result of the corresponding image-processing task.

Each of the data output lines 35a to 35d connected to the first output of a corresponding one of the first to fourth processing units 31a to 31d is connected to the output selector 39.

The output selector 39 is connected at its control terminal to the image-processing controller 17. In accordance with the control signals inputted from the selector switching unit 19 of the controller 17, the output selector 39 works to select one of the plurality of data output lines 35a to 35d connected thereto. In addition, the output selector 39 works to store the output data flowing through the selected one of the data output lines 35a to 35d in the image memory 15 as output of the image processor 131.

As described above, the image processor 131 according to the first embodiment is configured to:

switch the interconnections (interconnection topology) among the first to fourth processing units 31a to 31d in accordance with the control signals inputted from the selector switching unit 19 of the image-processing controller 17; and

perform pipelined image-processing tasks defined by the switched interconnections among the processing units 31a to 31d based on frame video data inputted from the video input unit 11.

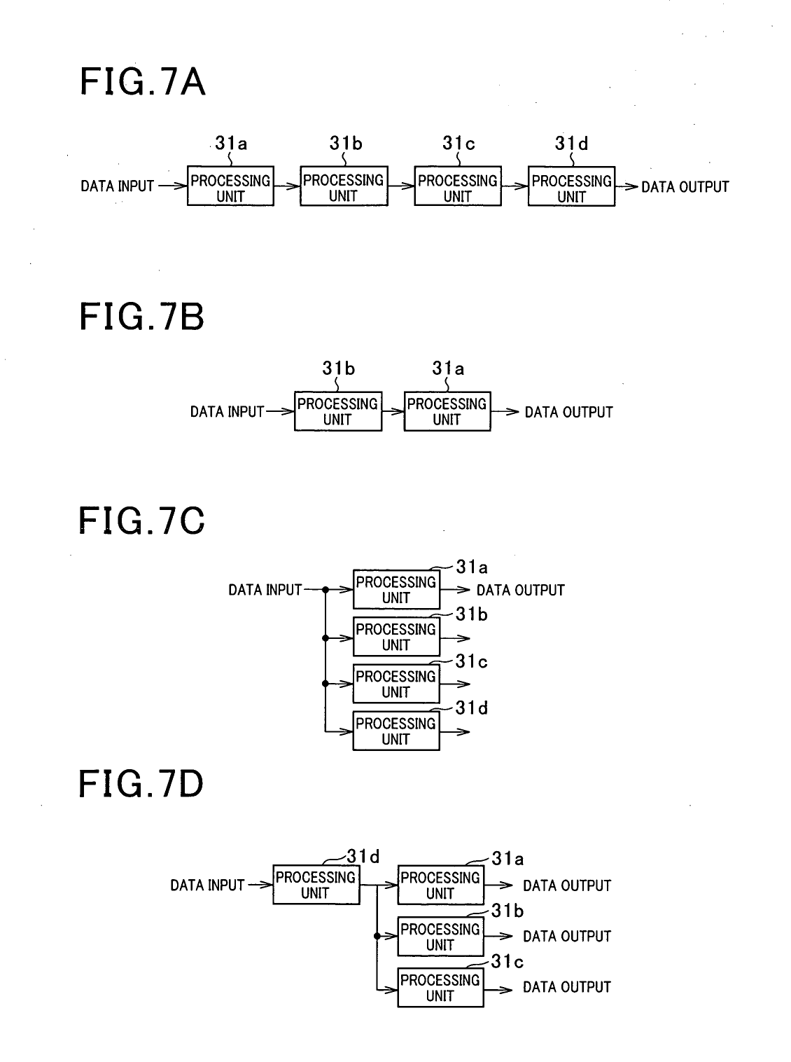

FIGS. 7A to 7B schematically illustrate interconnection patterns among the first to fourth processing units 31a to 31d.

FIG. 7A shows a first interconnection pattern in that the first, second, third, and fourth processing units 31a to 31d are connected in series in this order. When the first data input selector 33a selects the data input line 37, the second data input selector 33b selects the first data output line 35a, the third data input selector 33c selects the second data output line 35b, and the fourth data input selector 33d selects the third data output line 35c, the first interconnection pattern can be established.

In the image processor 131 having the first interconnection pattern, the frame video data inputted from the video input unit 11 is sequentially processed by the series-connected processing units 31a, 31b, 31c, and 31d. The result obtained by the sequential tasks of the processing units 31a to 31d based on the inputted frame video data is outputted from the output selector 39 to the image memory 15.

Note that the order of the series-connected processing units 31a to 31d can be changed by controlling the data input selectors 33a to 33d by the control signals inputted from the selector switching unit 19 of the image-processing controller 17.

Specifically, the four processing units 31a to 31b can be interconnected in accordance with the first interconnection patterns of the factorial of 4, and the frame video data inputted from the video input unit 11 is sequentially processed by the series-connected processing units 31a, 31b, 31c, and 31d. The result obtained by the sequential tasks of the processing unit 31a to 31d based on the inputted frame video data is outputted from the output selector 39 to the image memory 15.

FIG. 7B shows a second interconnection pattern in that some of the first to fourth processing units 31a to 31d are used. In other words, the second interconnection pattern is constructed without using at least one processing unit.

As an example of the second interconnection pattern, in FIG. 7B, the second and first processing units 31b and 31a are connected in series in this order. When the first data input selector 33a selects the second data output line 35b, the second data input selector 33b selects the data input line 37, the third data input selector 33c selects no data transfer lines (data output lines and data input line 37), and the fourth data input selector 33d selects no data transfer lines (data output lines and data input line 37), the second interconnection pattern illustrated in FIG. 7B can be established.

In the image processor 131 having the second interconnection pattern, the frame video data inputted from the video input unit 11 is sequentially processed by the series-connected processing units 31b and 31a. The result obtained by the sequential tasks of the processing unit 31b and 31a based on the inputted frame video data is outputted from the output selector 39 to the image memory 15.

FIG. 7C shows a third interconnection pattern in that the first, second, third, and fourth processing units 31a to 31d are parallely connected. When each of the first to fourth data input selectors 33a to 33d selects the data input line 37, the third interconnection pattern can be established.

In the image processor 131 having the third interconnection pattern, the frame video data inputted from the video input unit 11 is parallely processed individually by the processing units 31a, 31b, 31c, and 31d. The results obtained by the parallel tasks of the processing unit 31a to 31d based on the inputted frame video data are outputted from the output selector 39 to the image memory 15 under control of the image-processing controller 17.

FIG. 7D shows a fourth interconnection pattern in that at least one processing unit is connected in series to the video input unit 11, and the remaining processing unit(s) are parallely arranged and connected to the at least one processing unit.

As an example of the fourth interconnection pattern, in (d) of FIG. 7, the fourth processing unit 31d is connected in series to the video input unit 11, and the remaining processing units 31a 31 b, and 31c are parallely arranged and connected to the fourth processing unit 31d. When each of the first to third data input selectors 33a to 33c selects the fourth data output line 35d, and the fourth data input selector 33d selects the data input line 37, the fourth interconnection pattern illustrated in (d) of FIG. 7 can be established.

In the image processor 131 having the fourth interconnection pattern, the frame video data inputted from the video input unit 11 is firstly processed by the fourth processing unit 31d. The result obtained by the task of the fourth processing unit 31d based on the inputted frame video data is parallel processed individually by the first to third processing units 31a to 31c. The results obtained by the parallel tasks of the processing unit 31a to 31c are outputted from the output selector 39 to the image memory 15 under control of the image-processing controller 17.

In the first embodiment, as set fourth above, the video input unit 11 is configured to transmit, to the image processor 13, the digital video data as serial data. For this reason, in order to allow each of the first to fourth processing units 31a to 31d to properly perform an assigned image-processing task, the line synchronizing signal LS and the frame synchronizing signal FS are required to be input to each of the first to fourth processing units 31a to 31d.

When the first to fourth stages 31a to 31d are connected in series as one of the first interconnecting topology patterns, as compared with the timing when video data is inputted to one stage, the timing when the video data processed by the one stage is inputted to the next stage is delayed. For this reason, in the first embodiment, the image-processing controller 17 is configured such that the synchronizing signal LS and the frame synchronizing signal FS are not directly inputted to each of the first to fourth stages 31a to 31d

Specifically, the enable signal input unit 181 works to adjust the phases of the fame synchronizing signal FS and line synchronizing signal LS for each of the frame images to be suitable for the first to fourth processing units 31a to 31d. The enable signal input unit 181 also works to input, to each of the processing units 31a to 31d, a corresponding one of the adjusted frame synchronizing signals FS and a corresponding one of the adjusted frame synchronizing signals LS.

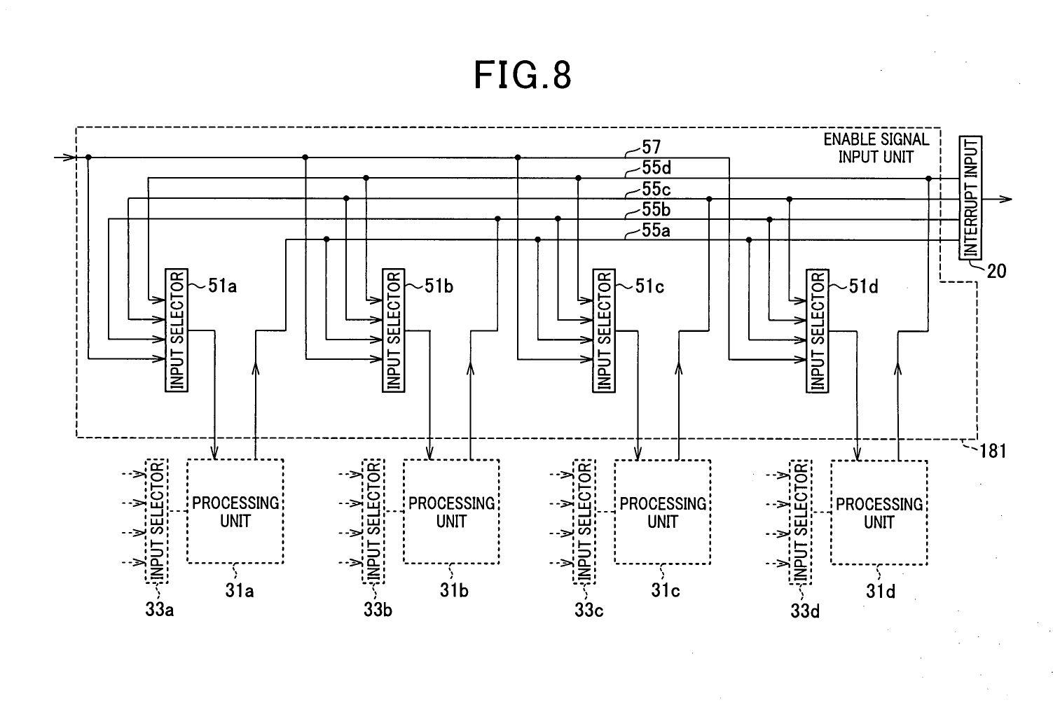

The hardware structure of the enable signal input unit 18, which is illustrated as an enable signal input unit 181 in FIG. 8, will be described hereinafter.

The enable signal input unit 181 is equipped with a first signal input selector 51a, a second signal input selector 51b, a third signal input selector 51c, and a fourth signal input selector 31d provided for the first processing unit 31a, the second processing unit 31b, the third processing unit 31c, and the fourth processing unit 31d, respectively.

Each of the first to fourth processing units 31a to 31d has a second output connected to a corresponding one of enable signal output lines 55a to 55d used to transfer the enable signals therefrom. Reference character 57 represents an enable signal input line connected to the video input unit 11 to allow the enable signals (fine synchronizing signal LS and the frame synchronizing signal FS) to be input to the enable signal input unit 181.

Each of the first to fourth signal input selectors 51a to 51d has an output connected to the control terminal of a corresponding one of the first to fourth processing units 31a to 31d. Each of the first to fourth signal input selectors 51a to 51d has four inputs connected to the enable signal input line 57 and the enable signal output lines 55a to 55d except for one enable signal output line connected to a second output of a corresponding one processing unit,

Specifically, the first signal input selector 51a is connected at its inputs to the enable signal input line 57, and the enable signal output lines 55b, 55c, and 55d respectively connected to the second outputs of the processing units 31b, 31c, and 31d.

The second signal input selector 51b is connected at its inputs to the enable signal input line 57, and the enable signal output lines 55a, 55c, and 55d respectively connected to the second outputs of the processing units 31a, 31c, and 31d.

The third signal input selector 51c is connected at its inputs to the enable signal input line 57, and the enable signal output lines 55a, 55b, and 55d respectively connected to the second outputs of the processing units 31a, 31b, and 31d.

The fourth signal input selector 51d is connected at its inputs to the enable signal input line 57, and the enable signal output lines 55a, 55b, and 55c respectively connected to the second outputs of the processing units 31a, 31b, and 31c.

Each of the first to fourth signal input selectors 51a to 51d is connected at its control terminal to the image-processing controller 17.

In accordance with the control signals inputted from the selector switching unit 19 of the controller 17, each of the first to fourth signal input selectors 51a to 51d works to select one of the plurality of enable signal transfer lines (the corresponding enable signal output lines and enable signal input line 57). In addition, each of the first to fourth signal input selectors 51a to 51d works to input, to the corresponding one of the processing units 31a to 31d, the enable signals flowing through the selected one of the plurality of enable signal transfer lines.

When receiving the enable signals, each of the first to fourth processing units 31a to 31d delays the output of the enable signals to a corresponding one enable signal output line by a predetermined period required to perform the corresponding image-processing task and to output the result of the image-processing task.

Specifically, when receiving pixel data Pi [x, y] in frame video data at the coordinate point (x, y), each of the first to fourth processing units 31a to 31d delays the output of the enable signals inputted thereto to a corresponding enable signal output line by a predetermined period; this predetermined period is required to output corresponding pixel data Po [x, y] at the coordinate point (x, y).

The enable signal output lines 55a, 55b, 55c, and 55d extending from the respective processing units 31a, 31b, 31c, and 31d are connected to the interrupt input unit 20. The enable signals flowing through each of the enable signal output lines 55a to 55d are inputted to the interrupt input unit 20.

In the first embodiment, the image-processing controller 18 is configured to determine one of various input patterns of the enable signals from the signal input selectors 51a to 51d to the corresponding processing units 31a to 31d to thereby adjust the phases of the line synchronizing signal LS and frame synchronizing signal FS such that:

the input timing of video data to each of the processing units 31a to 31d coincides with that of the enable signals to a corresponding one of the processing units 31a to 31d.

In addition, the image-processing controller 18 works to input, to each of the processing units 31a to 31d, a corresponding one of the adjusted frame synchronizing signals FS and a corresponding one of the adjusted frame synchronizing signals LS as the enable signals.

Specifically, when controlling the data input selectors 33a to 33d and the output selector 39, the selector switching unit 19 is configured to control each of the signal input selectors 51a to 51d to thereby determine one of various input patterns of the enable signals from the signal input selectors 51a to 51d to the corresponding processing units 31a to 31d such that:

one of the corresponding signal transfer lines is selected to be connected to a corresponding one processing unit to which one data transfer line corresponding to the selected one of the signal transfer lines is connected.

In other words, when controlling the data input selectors 33a to 33d and the output selector 39, the selector switching unit 19 is configured to control each of the signal input selectors 51a to 51d to thereby determine one of various input patterns of the enable signals from the signal input selectors 51a to 51d to the corresponding processing its 31a to 31d such that:

the determined one of the various input patterns of the enable signals from the signal input selectors 51a to 51d to the corresponding processing units 31a to 31d is matched with the determined one of the interconnection patterns among the first to fourth processing units 31a to 31d.

For example, when video data is inputted from the first data input selector 33a to the first processing unit 31a via the data input line 37 in accordance with an interconnection pattern, the selector switching unit 19 is configured to control the first signal input selector 51a such that the enable signals flowing through the enable signal input line 57 are inputted to the first processing unit 31a from the first signal input selector 51a.

Similarly, when video data is inputted from the second data input selector 33b to the second processing unit 31b via the data output line 35a in accordance with an interconnection pattern, the selector switching unit 19 is configured to control the second signal input selector 51b such that the enable signals flowing through the data output line 55a are inputted to the second processing unit 51b from the second signal input selector 51b.

In addition, when video data is inputted from the third data input selector 33c to the third processing unit 31c via the data output lie 35b in accordance with an interconnection pattern, the selector switching unit 19 is configured to control the third signal input selector 51c such that the enable signals lowing through the data output line 55b are inputted to the third processing unit 31c from the third signal input selector 31c.

Moreover, when video data is inputted from the fourth data input selector 33d to the fourth processing unit 31d via the data output line 35c in accordance with an interconnection pattern, the selector switching unit 19 is configured to control the fourth signal input selector 51d such that the enable signals flowing through the data output line 55c are inputted to the fourth processing unit 31d from the fourth signal input selector 51d.

For example, when the first to fourth stages 31a to 31d are connected in series as one of the first interconnecting topology patterns, the selector switching unit 19 is configured to control each of the signal input selectors 51a to 51d to thereby determine one of various input patterns of the enable signals from the signal input selectors 51a to 51d to the corresponding processing units 31a to 31d to be in agreement with the one of the first interconnecting topology patterns (see (a) of FIG. 7).

In the determined one of the first interconnecting topology pattern and the corresponding input pattern, the enable signals outputted from the video input unit 11 are inputted to the first stage 31a of the pipelined processing units 31a to 31d.

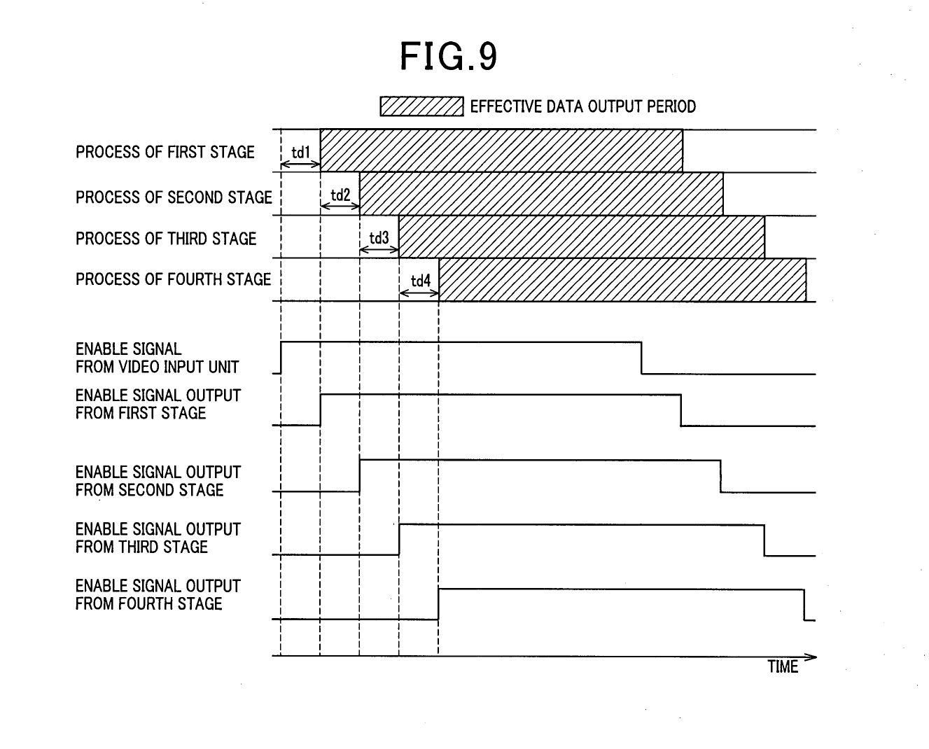

Referring to FIG. 9, from the first stage 31a, after a predetermined processing time (delay time) td1 of the first processing unit 31a has elapsed since the input of the enable signals from the video input unit 11, the enable signals inputted from the video input unit 11 are outputted so as to be inputted to the second stage 31b of the pipelined processing units 31a to 31d.

From the second stage 31b, after a predetermined processing time (delay time) td2 of the second processing unit 31b has elapsed since the input of the enable signals from the first stage 31a, the enable signals inputted from the first stage 31a are outputted so as to be inputted to the third stage 31c of the pipelined processing units 31a to 31d.

From the third stage 31c, after a predetermined processing time (delay time) td3 of the third processing unit 31c has elapsed since the input of the enable signals from the second stage 31b, the enable signals inputted from the second stage 31b are outputted so as to be inputted to the fourth stage 31d of the pipelined processing units 31a to 31d.

From the fourth stage 31d, after a predetermined processing time (delay time) td4 of the fourth processing unit 31d has elapsed since the input of the enable signals from the third stage 31c, the enable signals inputted from the third stage 31c are outputted so as to be inputted to the interrupt input unit 20.

Accordingly, in a state that at least some of the stages 31a to 31d are connected in series, even if the timing when the video data processed by one stage in the series-connected stages is inputted to the next stage is delayed relative to the timing when the video data is inputted to the one stage, the input timing of the enable signals to the next stage can be synchronized with the timing when the video data processed by the one stage is inputted to the next stage.

This allows each stage in some of the series-connected stages to smoothly carry out the corresponding image-processing task in response to the input of the video data and to output the result of the corresponding image processing task.

Under control of the microcomputer 21, the interrupt input unit 20 works to receive the enable signals outputted from at least one final stage of the processing units 31a to 31d as target enable signals for determining an interrupt timing. The interrupt input unit 20 also works to input, to the microcomputer 21, an interrupt request when the received target enable signals meet a predetermined interrupt condition.

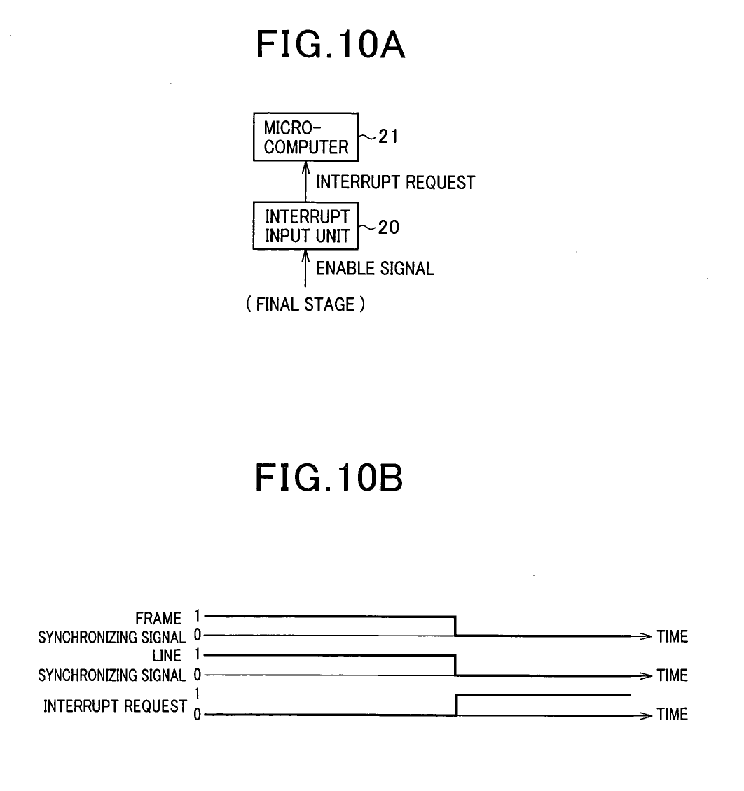

FIG. 10A schematically demonstrates an interrupt request to be inputted from the interrupt input unit 20 to the microcomputer 21, and FIG. 10B schematically demonstrates an input ting of an interrupt request to the microcomputer 21 from the interrupt input unit 20.

As illustrated in FIG. 10E, the interrupt input unit 20 is configured to input an interrupt request to the microcomputer 21 when both of the target enable signals (adjusted line synchronizing signal LS and frame synchronizing signal FS) are changed from the logical “1” to the logical “0”. This allows the interrupt input unit 20 to input an interrupt request to the microcomputer 21 every time the image processing tasks for one frame image are completed by the image processor 131 so that the frame video data corresponding thereto is stored in the image memory 15. The interrupt request allows the microcomputer 21 to grasp that the image processing tasks for one frame image are completed by the image processor 131.

Additionally, when receiving an interrupt request sent from the interrupt input request 20, the microcomputer 21 is programmed to:

read frame video data corresponding to at least one desired frame image to which the image processing tasks have been applied;

subject the readout frame video data to at least one image-processing task as need arises; and

output, to an external device, such as a display device, through the I/O interface 23, the frame video data that has been subjected to the at least one image-processing task.

As described above, the information processing device 1 according to the first embodiment is configured to merely control each of the input selectors 33a to 33d and 51a to 51d to thereby switchably select any one of the interconnection patterns among the processing units 31a 31b, 31c, and 31d integrated in the image processor 13 (131). This allows the information processing device 1 to carries out various image-processing tasks corresponding to the respective interconnection patterns.

For example, the information processing device 1 can switchably select one of the interconnection patterns among the processing units 31a, 31b, 31c, and 31d such that the first to fourth processing units 31a to 31d are connected in series in one of the orders equivalent to the factional of the number of the processing units 31a to 31d.

The information processing device 1 can switchably select one of the interconnection patterns among the processing units 31a, 31b, 31c, and 31d such that some of the first to fourth processing units 31a to 31d are connected in series while skipping the remaining processing unit(s).

The information processing device 1 can switchably select one of the interconnection patterns among the processing units 31a, 31b, 31c, and 31d such that the first to fourth processing units 31a to 31d are parallely connected.

The information processing device 1 can switchably select one of the interconnection patterns among the processing units 31a, 31b, 31c , and 31d such that:

at least two of the first to fourth processing units 31a to 31d are connected in series;

the remaining processing units are parallely connected; and

the series-connected processing units and the parallely connected processing units are connected in series.

Specifically, in the single information processing device 1 according to the first embodiment, it is possible to effectively share the first to fourth processing units 31a to 31d so as to carry out the various image-processing tasks. In other words, the first embodiment of the present invention can carry out the various image-processing tasks without using a plurality of hardware devices.

In addition, the information processing device 1 according to the first embodiment is configured to determine one of the various input patterns of the enable signals from the signal input selectors 51a to 51d to the corresponding processing units 31a to 31d to thereby adjust the phases of the enable signals (the line synchronizing signal LS and the frame synchronizing signal FS) such that:

the input timing of video data to each of the processing units 31a to 31d coincides with that of the enable signals to a corresponding one of the processing units 31a to 31d.

Specifically, it is assumed that at least some of the stages 31a to 31d are connected in series.

In this assumption, even if the timing when the video data processed by one stage in the series-connected stages is inputted to the next stage is delayed relative to the timing when the video data is inputted to the one stage, the input timing of the enable signals to the next stage can be synchronized with the timing when the video data processed by the one stage is inputted to the next stage.

This allows each stage in some of the series-connected stages to smoothly carry out the corresponding image-processing task in response to the input of the video data and to output the result of the corresponding image processing task.

The information processing device 1 according to the first embodiment is configured such that the output selector 39 works to select one of the data output lines 35a to 35d connected thereto under control of the controller 17. The configuration allows required output data flowing through the selected one of the data output lines to be transferred from the output selector 39 to the image memory 15. This reduces data output lines from the output selector 39, making it possible to simplify the downstream structure of the output selector 39 of the information processing device 1.

In the information processing device 1 according to the first embodiment, the interrupt input unit 20 can input, to the microcomputer 21, an interrupt request every time the image processing tasks for one frame image are completed by the image processor 131. This makes the hardware-based image-processing tasks by the image processor 131 easily collaborate the software-based image-processing tasks by the microcomputer 21. Thus, it is possible to effectively combine the hardware-based image-processing tasks by the image processor 131 and the software-based image-processing tasks, thereby efficiently performing image-processing tasks with respect to video data inputted to the information processing device 1.

### Second Embodiment

An information processing device according to a second embodiment of the present invention will be described hereinafter. The information processing device of the second embodiment has substantially the same structure as that of the information processing device 1 of the first embodiment except for the structure of the enable signal input 18. For this reason, like reference characters are assigned to like parts in the information processing devices according to the first and second embodiments so that descriptions of the parts of the information processing device of the second embodiment will be omitted or simplified.

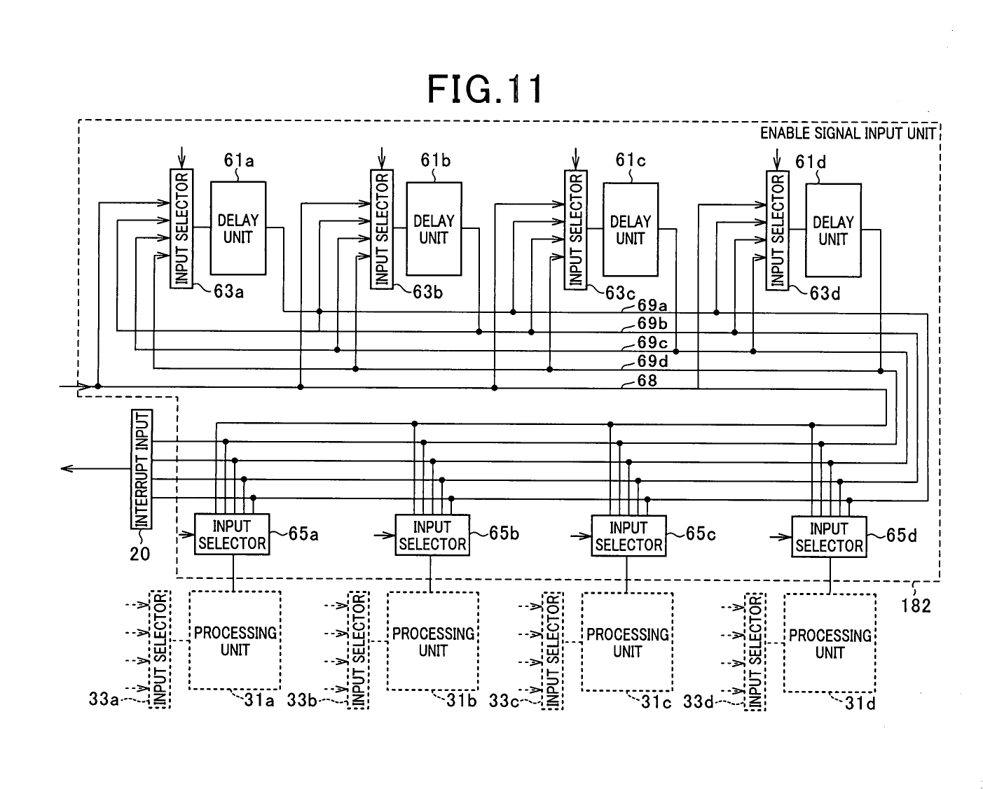

The hardware structure of the enable signal input unit 18 according to the second embodiment, which is illustrated as an enable signal input unit 182 in FIG. 11, will be described hereinafter.

The enable signal input unit 182 is equipped with a first delay unit 61a, a second delay unit 61b, a third delay unit 61c, and a fourth delay unit 61d provided for the first processing unit 31a, the second processing unit 31b, the third processing unit 31c, and the fourth processing unit 31d, respectively.

The enable signal input unit 182 is equipped with a first delay input selector 63a, a second delay input selector 63b, a third delay input selector 63c, and a fourth delay input selector 63d provided for the first delay unit 61a, the second delay unit 61b, the third delay unit 61c, and the fourth delay unit 61d, respectively.

In addition, the enable signal input unit 182 is equipped with a first signal input selector 65a, a second signal input selector 65b , a third signal input selector 65c , and a fourth signal input selector 65d provided for the first processing unit 31a, the second processing unit 31b, the third processing unit 31c, and the fourth processing unit 31d, respectively.

Each of the first to fourth delay units 61a to 61d has an output connected to a corresponding one of enable signal output lines 69a to 69d used to transfer the enable signals therefrom. Reference character 68 represents an enable signal input line connected to the video input unit 11 to allow the enable signals (line synchronizing signal LS and the frame synchronizing signal FS) to be input to the enable signal input unit 182.

As well as the first to fourth processing units 31a to 31d, when receiving the enable signals, each of the first to fourth delay units 61a to 61d delays the output of the enable signals to a corresponding one enable signal output line by a predetermined period required to perform the corresponding image-processing task and to output the result of the image-processing task by a corresponding one of the processing units 31a to 31d.

Specifically, when the enable signals arm inputted to the first delay unit 61a, the first delay unit 61a delays the output of the enable signals inputted thereto to the enable signal output line 69a by a predetermined period; this predetermined period is required for the corresponding processing unit 31a to:

perform the corresponding image-processing task based on pixel data in inputted frame video data at the coordinate point (x, y); and

output pixel data Po [x, y] obtained by the corresponding image-processing task at the coordinate point (x, y).

When the enable signals are inputted to the second delay unit 61b, the second delay unit 61b delays the output of the enable signals inputted thereto to the enable signal output line 69b by a predetermined period; this predetermined period is required for the corresponding processing unit 31b to:

perform the corresponding image-processing task based on pixel data in inputted frame video data at the coordinate point (x, y); and

output pixel data Po [x, y] obtained by the corresponding image-processing task at the coordinate point (x, y).

When the enable signals are inputted to the third delay unit 61c, the third delay unit 61c delays the output of the enable signals inputted thereto to the enable signal output line 69c by a predetermined period; this predetermined period is required for the corresponding processing unit 31c to:

perform the corresponding image-processing task based on pixel data in inputted frame video data at the coordinate point (x y); and

output pixel data Po [x, y] obtained by the corresponding image-processing task at the coordinate point (x, y).

When the enable signals are inputted to the fourth delay unit 61d, the fourth delay unit 61d delays the output of the enable signals inputted thereto to the enable signal output line 69d by a predetermined period; this predetermined period is required for the corresponding processing unit 31d to:

perform the corresponding image-processing task based on pixel data in inputted frame video data at the coordinate point (x, y); and

output pixel data Po [x, y] obtained by the corresponding image-processing task at the coordinate point (x, y).

Each of the first to fourth delay input selectors 63a to 63d has an output connected to an input of a corresponding one of the first to fourth delay units 61a to 61d. Each of the first to fourth delay input selectors 61a to 61d has four inputs connected to the enable signal input line 68 and the enable signal output lines 69a to 69d except for one enable signal output line connected to the output of a corresponding one delay unit.

Specifically, the first delay input selector 61a is connected at its inputs to the enable signal input line 68, and the enable signal output lines 69b, 69c, and 69d respectively connected to the outputs of the delay units 61b, 61c, and 61d.

The second delay input selector 61b is connected at its inputs to the enable signal input line 68, and the enable signal output lines 69a, 69c, and 69d respectively connected to the outputs of the delay units 61a, 61c, and 61d.

The third delay input selector 61c is connected at its inputs to the enable signal input line 68, and the enable signal output lines 69a, 69b, and 69d respectively connected to the outputs of the delay units 61a, 61b, and 61d.

The fourth delay input selector 61d is connected at its inputs to the enable signal input line 68, and the enable signal output lines 69a, 69b, and 69c respectively connected to the outputs of the delay units 61a, 61b, and 61c.

Each of the first to fourth delay input selectors 63a to 63d is connected at its control terminal to the image-processing controller 17.

In accordance with the control signals inputted from the selector switching unit 19 of the controller 17, each of the first to fourth delay input selectors 63a to 63d works to select one of the plurality of enable signal transfer lines (the corresponding enable signal output lines and enable signal input line 68). In addition, each of the first to fourth delay input selectors 63a to 63d works to input, to the corresponding one of the delay units 61a to 61d, the enable signals flowing through the selected one of the plurality of enable signal transfer lines.

Each of the first to fourth signal input selectors 65ato 65d has an output connected to the control terminal of a corresponding one of the first to fourth processing units 31a to 31d. Each of the first to fourth signal input selectors 65a to 65d has five inputs connected to the enable signal input line 68 and the enable signal output lines 69a to 69d.

Each of the first to fourth signal input selectors 65ato 65d is connected at its control terminal to the image-processing controller 17.

In accordance with the control signals inputted from the selector switching unit 19 of the controller 17, each of the first to fourth signal input selectors 65ato 65d works to select one of the plurality of enable signal transfer lines (the corresponding enable signal output lines and enable signal input line 57). In addition, each of the first to fourth signal input selectors 65ato 65d works to input, to the corresponding one of the processing units 31a to 31d, the enable signals flowing through the selected one of the plurality of enable signal transfer lines.

The enable signal output lines 69a, 69b, 69c, and 69d extending from the respective delay units 61a, 61b, 61c, and 61d are connected to the interrupt input unit 20. The enable signals flowing through each of the enable signal output lines 69a to 69d are inputted to the interrupt input unit 20.

In the second embodiment, the selector switching unit 19 is configured to determine one of various interconnection patterns among the first to fourth delay input selectors 63a to 63d such that

the determined one of the various interconnection patterns among the first to fourth delay input selectors 63a to 63d is matched with the determined one of the interconnection patterns among the first to fourth processing units 31a to 31d.

In addition, the selector switching unit 19 is configured to determine one of various input patterns of the enable signals from the signal input selectors 65ato 65d to the corresponding processing units 31a to 31d such that:

the determined one of the various input patterns of the enable signals from the signal input selectors 65ato 65d to the corresponding processing units 31a to 31d is matched with the determined one of the various interconnection patterns among the first to fourth delay input selectors 63a to 63d.

Specifically, the enable signal input unit 182 is configured to adjust the phases of the enable signals (the line synchronizing signal LS and the frame synchronizing signal FS) such that:

the input timing of video data to each of the processing units 31a to 31d coincides with that of the enable signals to a corresponding one of the processing units 31a to 31d.

This allows the adjusted enable signals to be inputted to each of the processing units 31a to 31d.

Specifically, when controlling the data input selectors 33a to 33d and the output selector 39, the selector switching unit 19 is configured to control each of the delay input selectors 63a to 63d such that one of the corresponding signal transfer lines, which is selected by a corresponding one of the data input selectors 33a to 33d, is selected.

In the second embodiment, the data input line 37, the data output line 35a, data output line 35b, data output line 35c, and data output line 35d correspond to the enable signal input line 68, the enable signal output line 69a, enable signal output line 69b, enable signal output line 69c, and enable signal output line 69d, respectively.

In parallel with the control of the signal input selectors 63a to 63d, the selector switching unit 19 is configured to control each of the signal input selectors 65a to 65d such that one of the corresponding signal transfer lines, which is selected by a corresponding one of the delay input selectors 63a to 63d, is selected. In the second embodiment, the delay input selectors 63a, 63b, 63c, and 63d correspond to the signal input selectors 65a, 65b, 65c, and 65d, respectively.

Specifically, the selector switching unit 19 is configured to:

determine one of various interconnection patterns among the first to fourth delay input selectors 63a to 63d such that the determined one of the various interconnection patterns among the first to fourth delay input selectors 63a to 63d is matched with the determined one of the interconnection patterns among the first to fourth processing units 31a to 31d; and

determine one of various input patterns of the enable signals from the signal input selectors 65a to 65d to the corresponding processing units 31a to 31d such that the determined one of the various input patterns of the enable signals from the signal input selectors 65ato 65d to the corresponding processing units 31a to 31d is matched with the determined one of the various interconnection patterns among the first to fourth delay input selectors 63a to 63d.

The operations of the selector switching unit 19 allows the input timing of video data to each of the processing units 31a to 31d to coincide with that of the enable signals to a corresponding one of the processing units 31a to 31d.

Under control of the microcomputer 21, the interrupt input unit 20 works to receive the enable signals outputted from at least one final stage of the delay units 61a to 61d as target enable signals for determining an interrupt timing. The interrupt input unit 20 also works to input, to the microcomputer 21, an interrupt request when the received target enable signals meet the predetermined interrupt condition described in the first embodiment.

In the second embodiment, in contrast with the function structures of the processing units 31a to 31d according to the first embodiment, each of the processing units 31a to 31d includes no functions of delaying the output of the enable signals inputted thereto by a predetermined period.

Specifically, it is assumed that at least some of the stages 31a to 31d are connected in series in accordance with one of the various interconnection patterns.

In this assumption, when video data is inputted from the previous stage in the series-connected stages to one stage therein, and the enables signals are inputted from the enable signal input unit 182, the one stage is configured to perform the corresponding image-processing task based on the inputted video data and enable signals. After completion of the corresponding image-processing task, the one stage is configured to output the result of the corresponding image-processing task.

In the second embodiment, video data outputted from at least one final stage in the first to fourth processing units 31a to 31d is stored in the image memory 15. When frame video data corresponding to at least one desired frame image is stored in the image memory 15, the microcomputer 21 is programmed to;

read the frame video data from the image memory 15 in response to input of an interrupt request inputted from the interrupt input unit 20

subject the readout frame video data to at least one image-processing task as need arises; and

output, to an external device, such as a display device, through the I/O interface 23, the frame video data that has been subjected to the at least one image-processing task.

As described above, the information processing device according to the second embodiment can achieve the same effects as those achieved by the information processing device 1 according to the first embodiment

Particularly, the enable signal input unit 182 according to the second embodiment is configured to adjust the phases of the enable signals (the line synchronizing signal LS and the frame synchronizing signal FS) such that:

the input timing of video data to each of the processing units 31a to 31d coincides with that of the enable signals to a corresponding one of the processing units 31a to 31d.

Thus, when at least some of the stages 31a to 31d are connected in series, even if the timing when the video data processed by one stage in the series-connected stages is inputted to the next stage is delayed relative to the timing when the video data is inputted to the one stage, the input timing of the enable signals to the next stage can be synchronized with the timing when the video data processed by the one stage is inputted to the next stage.

This allows, each stage in some of the series-connected stages to smoothly carry out the corresponding image-processing task in response to the input of the video data and the enable signals without installing the signal delaying function in each of the stages.

### Third Embodiment

An information processing device according to a third embodiment of the present invention will be described hereinafter. The information processing device of the third embodiment has substantially the same in structure as that of the information processing device 1 of the first embodiment except for the structures of the image processor 13 and the enable signal input 18. For this reason, like reference characters are assigned to like parts in the information processing devices according to the first and third embodiments so that descriptions of the parts of the information processing device of the third embodiment will be omitted or simplified.

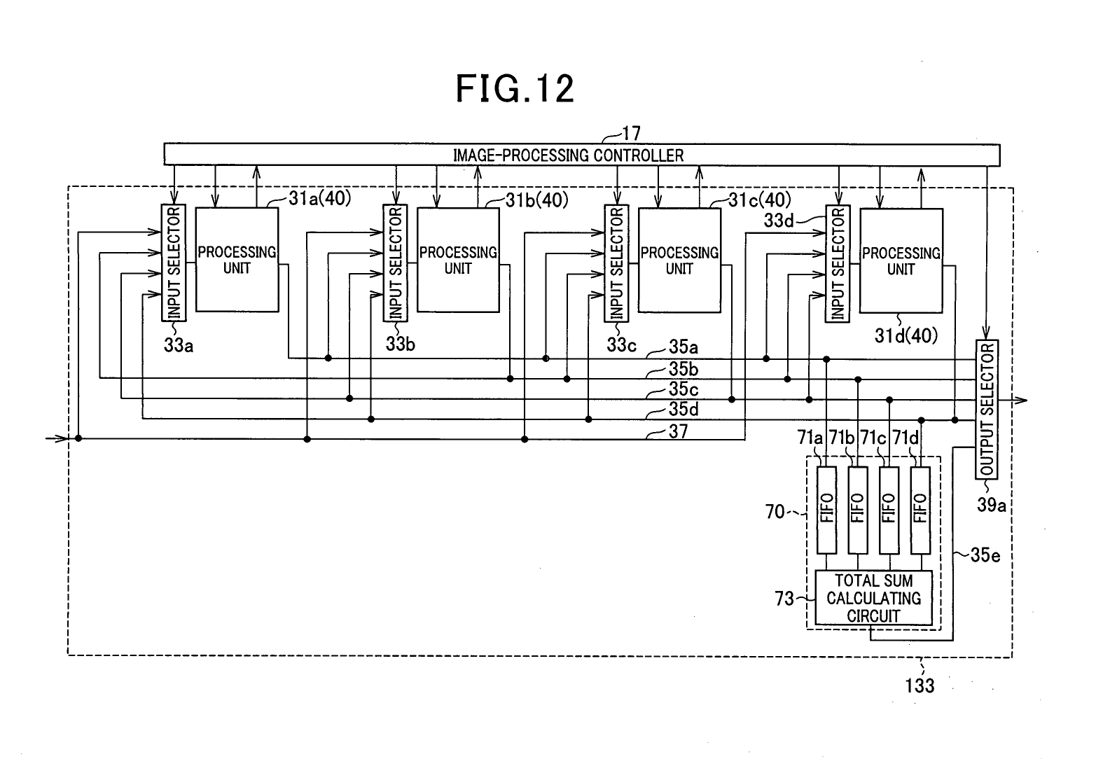

The hardware structure of the image processor 13 operable in a second basic processing mode according to the third embodiment, which is illustrated as an image processor 133 in FIG. 12, will be described hereinafter.

The image processor 133 according to the third embodiment is equipped with the first processing unit 31a, second processing unit 31b, third processing unit 31c, and fourth processing unit 31d. Like the first embodiment, each of the first to fourth processing units 31a to 31d is integrated with the convolution unit 40. In other words, the image processor 133 is provided with the first to fourth stages 31a to 31d of convolution.

In addition, the image processor 133 is equipped with a data combining unit 70.

The data combining unit 70 is connected to each of the data output lines 35a to 35d.

The image processor 133 is configured to obtain, based on the m×m matrix convolution, the result of an n×n matrix convolution without actually using an n×n convolution unit (n is an integer and set to be greater than m).

The image processor 133 is also equipped with a data output line 35e connected to an output of the combining unit 70 and to the output selector 39a together with the data output lines 35a to 35d.

The data combining unit 70 is provided with first to fourth FIFO line buffers 71a to 71d provided for the respective processing units 31a to 31d. The data combining unit 70 is also provided with a total sum calculating circuit 73 arranged at the output stage of each of the line buffers 71a to 71d.

The first line buffer 71a has an input connected to the data output line 35a extending from the first processing unit 31a. The first line buffer 71a works to temporarily store output data from the first processing unit 31a so as to delay it by a predetermined period, and output the delayed output data to the total sum calculating circuit 73.

The second line buffer 71b has an input connected to the data output line 35b extending from the second processing unit 31b. The second line buffer 71b works to temporarily store output data from the second processing unit 31b so as to delay it by a predetermined period, and output the delayed output data to the total sum calculating circuit 73.

The third line buffer 71c has an input connected to the data output line 35c extending from the third processing unit 31c. The third line buffer 71c works to temporarily store output data from the third processing unit 31c so as to delay it by a predetermined period, and output the delayed output data to the total sum calculating circuit 73.

The fourth line buffer 71d has an input connected to the data output line 35d extending from the fourth processing unit 31d. The fouth line buffer 71d works to temporarily store output data from the fourth processing unit 31d so as to delay it by a predetermined period, and output the delayed output data to the total sum calculating circuit 73.

The first to fourth line buffers 71a to 71d respectively have different sizes (different memory capacities) of predetermined bits; this size of each of the first to fourth line buffers 71a to 71d meets a corresponding predetermined condition.

Specifically, each of the first to fourth line buffers 71a to 71d works to:

delay output data being inputted thereto from a corresponding data transfer line by a predetermined period defined by its size; and

input the delayed output data to the total sum calculating circuit 73 at a timing different from that for another one of the first to fourth line buffers 71a to 71d.

The predetermined condition for each of the line buffers 71a to 71d defining the size thereof allows the image processor 133 to obtain, based on the processing units 31a to 31d with the m×m kernel matrix, the result of an n×n matrix convolution without actually using an n×n convolution unit.

In order to obtain, based on the 3×3 kernel matrix, the result Ps [x, y] of a 5×5 matrix convolution without actually using a 5×5 convolution unit, the first to fourth processing units 31a to 31d are parallely connected. This allows video data flowing through the data input line 37 from the video input unit 11 to be directly inputted to each of the processing units 31a to 31d.

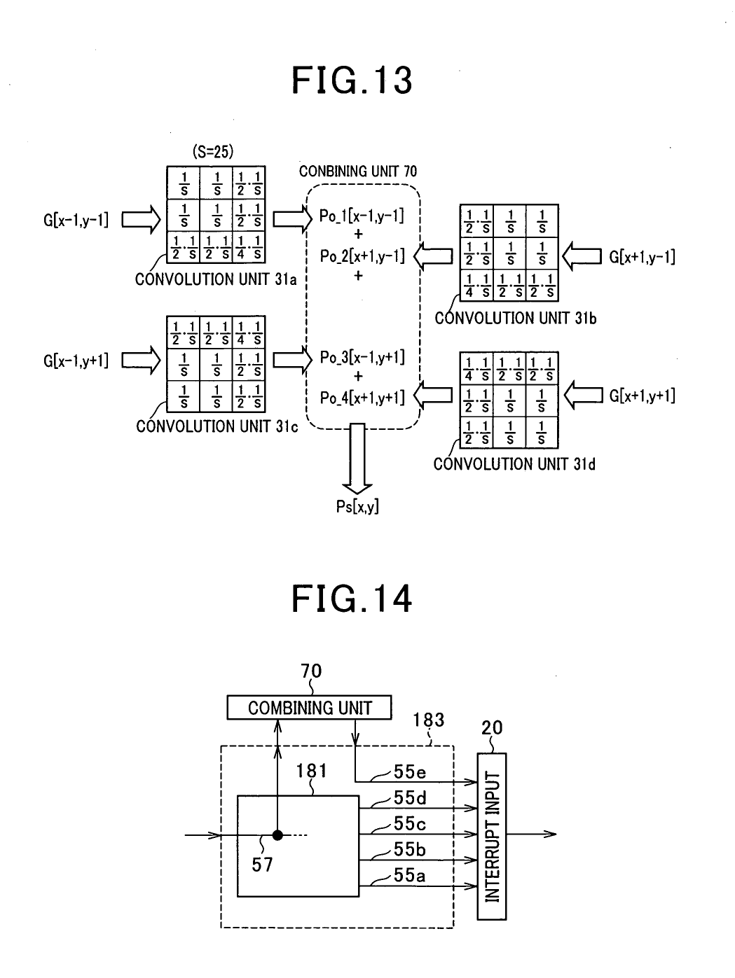

FIG. 13 schematically shows how to obtain the result Ps [x, y] of the 5×5 matrix convolution with the use of the processing units 31a to 31d each with the 3×3 kernel matrix. In particular, FIG. 13 schematically shows how to perform a smoothing task based on the convolution task.

It is assumed that a 5×5 kernel coefficient matrix H is set for a convolution unit; this 5×5 kernel coefficient matrix consists of “h [−2, −2], h [−1, −2], h [0, −2], h [1, −2], h [0, −2], h [1, −2], h [2, −2, h [2, −2], h [−2, −1], . . . , h [0, 0], . . . , h [2, 1], h [−2, 2], h [−1, 2], h [0, 2 , h [1, 2], and h[2, 2]”.

In order to obtain, based on each of the processing units 31a to 31d with the 3×3 kernel coefficient matrix, the result Ps [x, y] of a 5×5 matrix convolution without actually using a 5×5 convolution unit, a 3×3 kernel coefficient matrix H of the first processing unit 31a is set; this 3×3 kernel coefficient matrix H consists of “h [−2, −2], h [−1, −2], (½)·h [0, −2], h [−2, −1], h [−1, −1], (½)·h [0, −1], (½)·h [−2, 0], (½)·h [−1, 0], and (¼)·h [0, 0]”.

Similarly, a 3×3 kernel coefficient matrix H of the second processing unit 31b is set; this 3×3 filter coefficient H consists of “(½)·h [0, −2], h [1, −2, h [2,−2], (½)·h [0, −1], h [1, −1], h [1, −1], h [2, —1], (¼)·h [0, 0], (½)·h [1, 0], and (½)·h [2, 0]”.

In addition, a 3×3 kernel coefficient matrix H of the third processing unit 31c is set; this 3×3 kernel coefficient matrix H consists of “(½)·h [−2, 0], (½)·h [−1, 0], (¼)·h [0, 0], h [−2, 1], h [−1, 1], (½)·h [0, 1], h [−2, 2], h [−1, 2], and (½)·h [0, 2]”.

Moreover, a 3×3 kernel coefficient matrix H of the fourth processing unit 31d is set; this 3×3 kernel coefficient matrix H consists of “(¼)·h [0, 0], (½)·h [1, 0], (½)·h [2, 0], (½)·h [0, 1], h [1,1], h [2, 1], (½)·h [0, 2], h [1, 2], and h [2, 2]”.

After the setting of the 3×3 kernel coefficient matrix H of each of the first to fourth processing units 31a to 31d, a 3×3 pixel matrix G[x−1, y−1 at the center coordinate of (x−1, y−1) is convolved by the first processing unit 31a so that output pixel data Po_1 [x−1, y−1] at the coordinate point (x−1, y−1) is obtained

A 3×3 pixel matrix G[x+1, y−1] at the center coordinate of (x+1, y−1) is convolved by the second processing unit 31b so that output pixel data Po_2 [x+1, y−1] at the coordinate point (x+1, y−1) is obtained.

A 3×3 pixel matrix G[x−1, y+1] at the center coordinate of (x−1, y+1) is convolved by the third processing unit 31c so that output pixel data Po_3 [x−1, y+1] at the coordinate point (x−1, y+1) is obtained.

A 3×3 pixel matrix G[x+1, y+1) at the center coordinate of (x+1, y+1) is convolved by the fourth processing unit 31d so that output pixel data Po_[x+1, y+1] at the coordinate point (x+1, y+1) is obtained.

The pieces of pixel data Po_1 [x−1, y−1], Po_2 [x+1, y−1]Po_3 [x−1, y+1], and Po_4 [x+1, y+1] are inputted to the total sum calculating circuit 73 via the line buffers 71a, 71b, 71c, and 71d, respectively.

The total sum calculating circuit 73 works to obtain the total sum Σ of the pieces of pixel data Po_1 [x−1, y−1, Po_2 [x+1, y−1], Po_3 [x−1, y+1], and Po_4 [x+1, y+1] in accordance with the following equation:

Σ=Po_{—}1 [x−1, y−1]+Po_{—}2 [x+1, y−1], +Po_{—}3 [x−1, y+1], +Po_{—}4 [x+1, y+1]

The total sum Σ obtained by the image processor 133 is matched with the result Ps [x, y] obtained by convolving a 5×5 pixel matrix at the center coordinate of (x, y) with the use of a 5×5 convolution unit.

As described above, in the third embodiment, the method illustrated in FIG. 13 and described above allows the image processor 133 to perform the convolution based on a kernel coefficient matrix with a size greater than that of the kernel coefficient matrix installed in each of the processing units 31a to 31d.

Specifically, in the structure of the image processor 133, the output pixel data Po_{—1 [x-}1, y−1] is required to be inputted to the total sum calculating circuit 73 through the first line buffer 71a at a timing when the output pixel data Po_4 [x+1, y+1) is inputted to the total sum calculating circuit 73 through the fourth line buffer 71d. For reason, he size of the first line buffer 71a is determined to meet the condition in that the output pixel data Po_1 [x−1, y−1] and the output pixel data Po_4 [x+1, y+1) are inputted to the total sum calculating circuit 73 in synchronization with each other.

Similarly, the output pixel data Po_2 [x+1, y−1] is required to be inputted to the total sum calculating circuit 73 through the second line buffer 71b at a timing when the output pixel data Po_4 [x+1 y+1] is inputted to the total sum calculating circuit 73 through the fourth line buffer 71d. For this reason, the size of the second line buffer 71b is determined to meet the condition in that the output pixel data Po_2 [x+1, y−1] and the output pixel data Po_4 [x+1, y+1] are inputted to the total sum calculating circuit 78 in synchronization with each other. The output pixel data Po_3 [x−1, y+1] is required to be inputted to the total sum calculating circuit 73 through the third line buffer 71c at a timing when the output pixel data Po_4 [x+1, y+1] is inputted to the total sum calculating circuit 73 through the fourth line buffer 71d. For this reason, the size of the third line buffer 71c is determined to meet the condition in that the output pixel data Po_3 [x−1, y+1] and the output pixel data Po_4 [x+1, y+1] are inputted to the total sum calculating circuit 73 in synchronization with each other.

As described above, when the pieces of pixel data Po_[x−1, y−1], Po_2 [x+1, y_{—}1], Po_3 [x−1, y+1], and Po_4 [x+1, y+1] are inputted to the total sum calculating circuit 73 in synchronization with each other, the total sum calculating circuit 73 works to obtain the total sum Σ of the pieces of pixel data Po_1 [x−1, y−1], Po_2 [x+1, y−1], Po_3 [x−1, y+1], and Po_4 x+1, y+1].

The total sum calculating unit 73 also works to output, to the output selector 39a through the data output line 35e, the result Ps [x, y] of the convolution with a kernel size greater than that of the kernel coefficient matrix installed in each of the processing units 31a to 31d.

In accordance with the control signals inputted from the selector switching unit 19 of the controller 17, the output selector 39a works to select one of the plurality of data output lines 35a to 35e connected thereto. In addition, the output selector 39a works to store the output data flowing through the selected one of the data output lines 35a to 35e in the image memory 15 as output of the image processor 133.

The hardware structure of the enable signal input unit 18 according to the third embodiment, which is illustrated as an enable signal input unit 183 in FIG. 14, will be described hereinafter.

The enable signal input unit 183 is equipped with the enable signal input unit 181 according to the first embodiment (see FIG. 8). The enable signal input line 57 of the enable signal input unit 181 is connected to the combining unit 70 in addition to the input of each of the first to fourth input selectors 51a to 51d.

The combining unit 70 also works to delay the enable signals inputted through the signal input line 57 by a predetermined period, and thereafter output the enable signals to the enable signal output line 55e. The predetermined period is a period from the pixel data Pi [x, y] in frame video data at the coordinate point (x, y) having been inputted thereto to the corresponding pixel data Ps [x, y] at the coordinate point (x, y) being outputted from the total sum calculating circuit 73.

The enable signal input line 55e allows the enable signals flowing therethrough to be inputted to the interrupt input unit 20 in addition to the enable signals flowing through the enable signal input lines 55a to 55d.

Specifically, in the third embodiment, tie interrupt input unit 20 is configured to input an interrupt request to the microcomputer 21 when both of the target enable signals (adjusted line synchronizing signal LS and frame synchronizing signal FS) inputted from the combining unit 70 are changed from the logical “1” to the logical “0”. This allows the interrupt input unit 20 to input an interrupt request to the microcomputer 21 every time the image processing tasks for one frame image are completed by the image processor 131 so that the frame video data corresponding thereto is stored in the image memory 15.

As described above, the information processing device according to the third embodiment can achieve the same effects as those achieved by the information processing device 1 according to the first embodiment

Particularly, the image processor 133 of the information processing device according to the third embodiment is configured to obtain, based on the processing units 31a to 31d with the m×m kernel coefficient matrix, the result of an n×n matrix convolution without actually using an n×n convolution unit greater in kernel size than each of the processing units having the m×m kernel coefficient matrix.

Thus, it is unnecessary to provide an n×n convolution unit in each of the processing units 31a to 31d in order to obtain the result of an n×n matrix convolution, making it possible to maintain compact the kernel size of each of the processing units 31a to 31d.

### Fourth Embodiment

An information processing device according to a fourth embodiment of the present invention will be described hereinafter. The information processing device of the fourth embodiment has substantially the same structure as that of the information processing device 1 of the first embodiment except for the structure of the image processor 13. For this reason, like reference characters are assigned to like parts in the information processing devices according to the first and fourth embodiments so that descriptions of the parts of the information processing device of the fourth embodiment will be omitted or simplified.

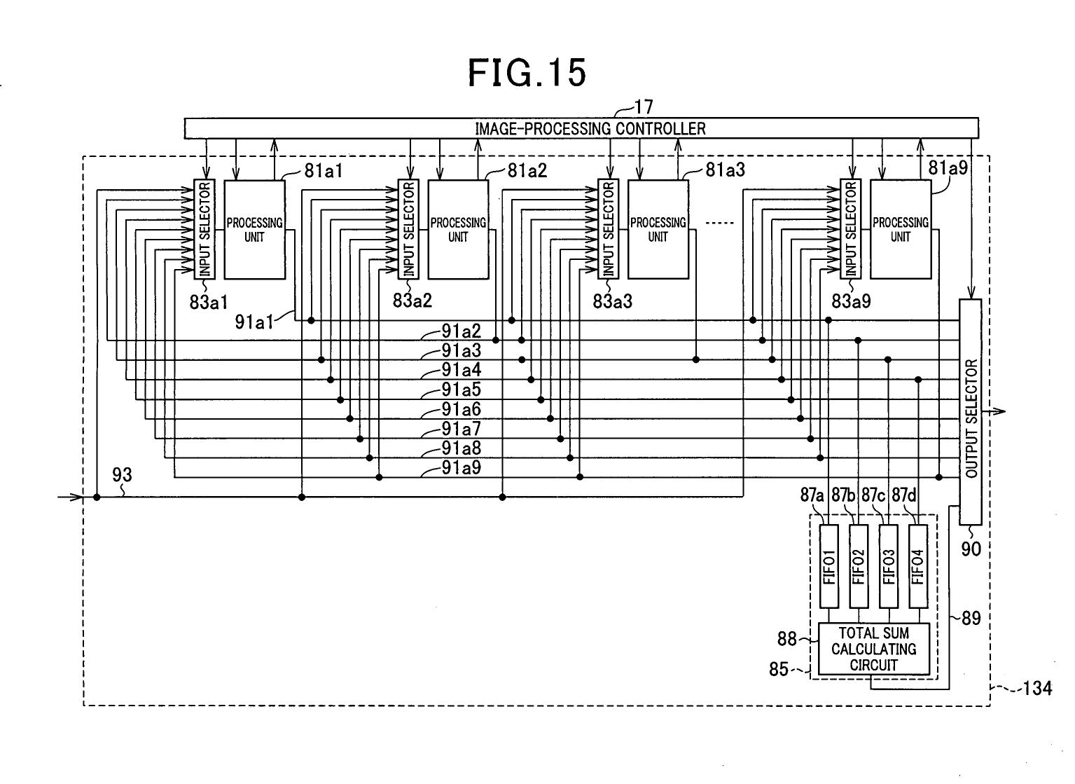

The hardware structure of the image processor 13 operable in an application processing mode according to the fourth embodiment, which is illustrated as an image processor 134 in FIG. 15, will be described hereinafter.

The image processor 134 according to the fourth embodiment is equipped with nine processing units (nine stages) 81a1 to 81a9, nine data input selectors 83a1 to 83a9 respectively provided therefor, a combining unit 85, and a data output selector 90.

Specifically, the image processor 134 is equipped, as the processing units 81a1 to 81a9, two gradation units, one erosion unit, one dilation unit, four convolution units each with a 3×3 kernel coefficient matrix, and a inter-image processing unit.

In the fourth embodiment, for example, the processing units 81a1 to S1a4 serve as the four convolution units, the processing units 81a5 and 81a6 serve as the two gradation conversion units, and the processing unit 81a7 serves as the erosion unit. In addition, the processing unit 81a8 serves as the dilation unit, and the processing unit 81a9 serves as the inter-image processing unit.

In the image processor 134, like the first to third embodiments, each of the processing units 81a1 to 81a9 has a first output connected to a corresponding one of nine data output lines 91a1 to 91a9. Reference character 93 represents a data input line connected to the video input unit 11 to allow the pieces of the frame video data to be input to the image processor 134.

Like the data input units 33a to 33d, each of the data input selectors 83a1 to 83a9 has nine inputs connected to the data input line 93 and the data output lines 91a1 to 91a9 except for the one data output line connected to the first output of a corresponding one processing unit.

For example, the data input selector 83a2 is connected at its inputs to the data output lines 91a1 , 91a3 , 91a4, 91a5, 91a6, 91a7, 91a8, and 91a9 and to the data input line 93. The data input selector 83a8 is also connected at its output to the input of the corresponding processing unit 81a2.

Each of the data input selectors 83a1 to 83a9 is connected at its control terminal to the image-processing controller 17. In accordance with the control signals inputted from the selector switching unit 19 of the controller 17, each of the data input selectors 83a1 to 83a9 works to select one of the plurality of data transfer lines (the corresponding data output lines and data input line 93). In addition, each of the data input selectors 83a1 to 83a9 works to input, to the corresponding one of the processing units 81a1 to 81a9, frame video data flowing through the selected one of the plurality of data transfer lines.

As well as the combining unit 70, the data combining unit 90 is connected to each of the data output lines 91a1 to 91a9.

The data combining unit 90 is provided with first to fourth FIFO line buffers 87a to 87d provided for the respective processing units (convolution nits) 81a1 to 81a4. The data combining unit 90 is also provided with a total sum calculating circuit 88 arranged at the output stage of each of the nine buffers 87a to 87d.

Each of the first to fourth line buffers 87a to 87d has an input connected to a corresponding one of the data output lines 91a1 to 91a4 extending from the processing units 81a1 to 81a4. Each of the first to fourth line buffers 87a to 87d works to temporarily store output data from a corresponding one of the processing units 81a1 to 81a4, delay it by a predetermined period, and output the delayed output data to the total sum calculating circuit 88.

The first to fourth line buffers 87a to 87d respectively have different sizes (different memory capacities) of predetermined bits; this size of each of the first to fourth line buffers 87a to 87d meets the corresponding predetermined condition described in the third embodiment.

Specifically, each of the first to fourth line buffers 87a to 87d works to:

delay output data being inputted thereto from a corresponding data transfer line by a predetermined period defined by its size; and

input the delayed output data to the total sum calculating circuit 88 at a timing different from that for another one of the first to fourth line buffers 87a to 87d.

The predetermined condition for each of the line buffers 87a to 87d defining the size thereof allows the image processor 134 to obtain, based on the processing units 81a1 to 81a4 with the m×m kernel matrix, the result of an n×n matrix convolution without actually using an n×n convolution unit.

The output selector 90 is connected at its inputs to the data output lies 91a1 to 91a9 and a data output line 89 of the combining unit 85. The output selector 90 is also connected at its control terminal to the image-processing controller 17. In accordance with the control signals inputted from the selector switching unit 19 of the controller 17, the output selector 90 works to select one of the data output lines 89 and 91a1 to 91a9 connected thereto. In addition, the output selector 90 works to store the output data flowing through the selected one of the data output lines 89 and 91a1 to 91a9 in the image memory 15 as output of the image processor 134.

Like the first embodiment, the image processor 134 according to the fourth embodiment is configured to:

select one of the plurality of data transfer lines (the corresponding data output lines and data input line 93) to thereby switch the interconnections (interconnection topologies) among the processing units 81a1 to 81a9 in accordance with the control signals inputted from the selector switching unit 19 of the image-processing controller 17; and

perform pipelined image-processing tasks defined by the switched interconnections among the processing units 81 a1 to 81a9 based on frame video data corresponding to an x-y dimensional frame image and inputted from the video input unit 11.

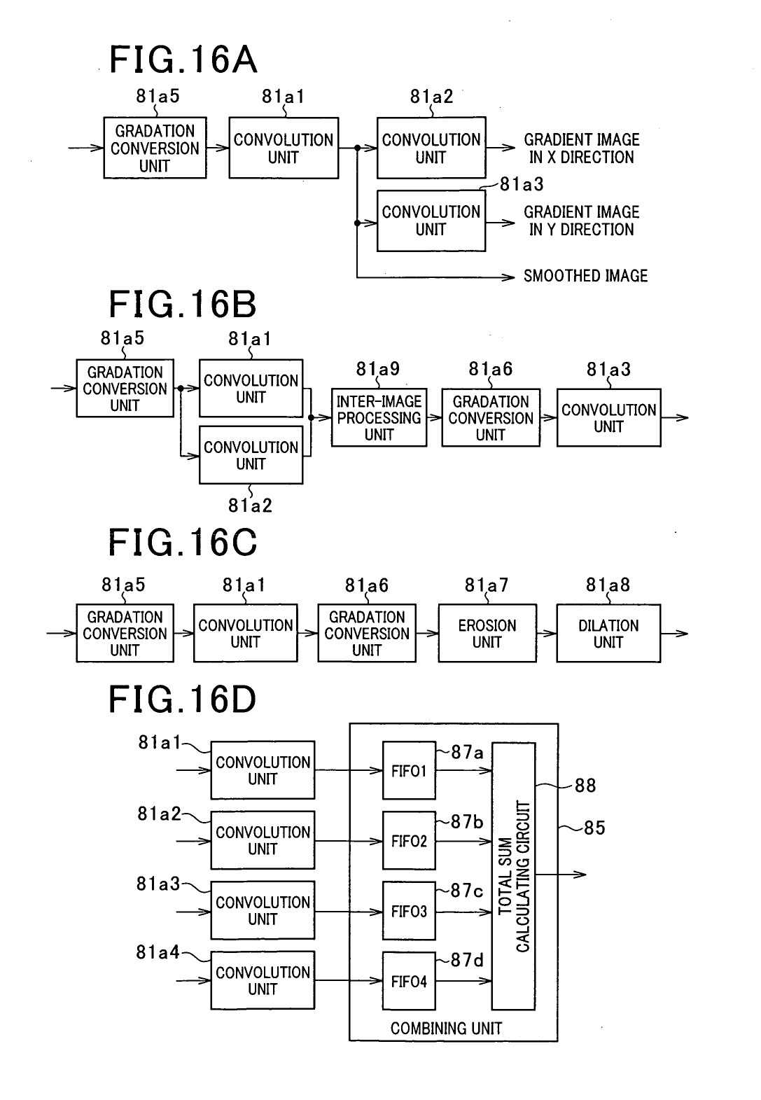

FIG. 16 schematically illustrates interconnection patterns among the processing units 81a1 to 81a9 for carrying out a plurality of image-processing tasks including a preprocessing task of a gradient method for optical-flow estimation, an edge-detection task, a preprocessing task of labeling, and a filtering task with a 5×5 kernel coefficient matrix.

Specifically, in order to perform the preprocessing task of the gradient method for optical-flow estimation by the image processor 134, the image processor 134 selects one of the interconnection patterns among the processing units 81a1 to 81a9 in accordance with the control signals inputted from the selector switching unit 19 of the image-processing controller 17.

FIG. 16A shows the selected one of the interconnection patterns among the processing its 81a1 to 81a9 for the preprocessing task of the gradient method for optical-flow estimation in that:

the gradation conversion unit 81a5 is set as the first stage;

the convolution unit 81a1 is set as the second stage to be connected in series to the first stage; and

the parallely connected convolution units 81a2 and 81a3 are set as the third stage to be connected in series to the second stage.

Setting of the kernel coefficient mates H of the convolution units 81a1 to 81a3 to be different from each other allows:

the convolution unit 81a1 at the second stage to perform a smoothing task based on frame video data; and

the convolution units 81a2 and 81a3 at the third stage to obtain a gradient image in the x direction and that in the y direction, respectively.

In accordance with the control signals inputted from the selector switching unit 19 of the image-processing controller 17, the output selector 90 selects the data output line 91a1 for the convolution unit 81a1 at the second stage, and the data output lines 91a2 and 91a3 for the convolution units 81a2 and 81a3 at the third stage,

This allows output data from each of tie convolution units 81a1, 81a2, and 81a3 to be written into the image memory 15. In other words, smoothed image data, the gradient image data in the x direction, and the gradient image data in the y direction corresponding to frame video data inputted from the video input unit 11 to the image processor 134 are stored in the image memory 15.

Specifically, in the fourth embodiment, the image processor 134 is configured to perform the preprocessing task of the gradient method for optical-flow estimation. This allows the microcomputer 21 to estimate optical flows based on the smoothed image data, the gradient image data in the x direction, and the gradient image data in the y direction stored in the image memory 15.

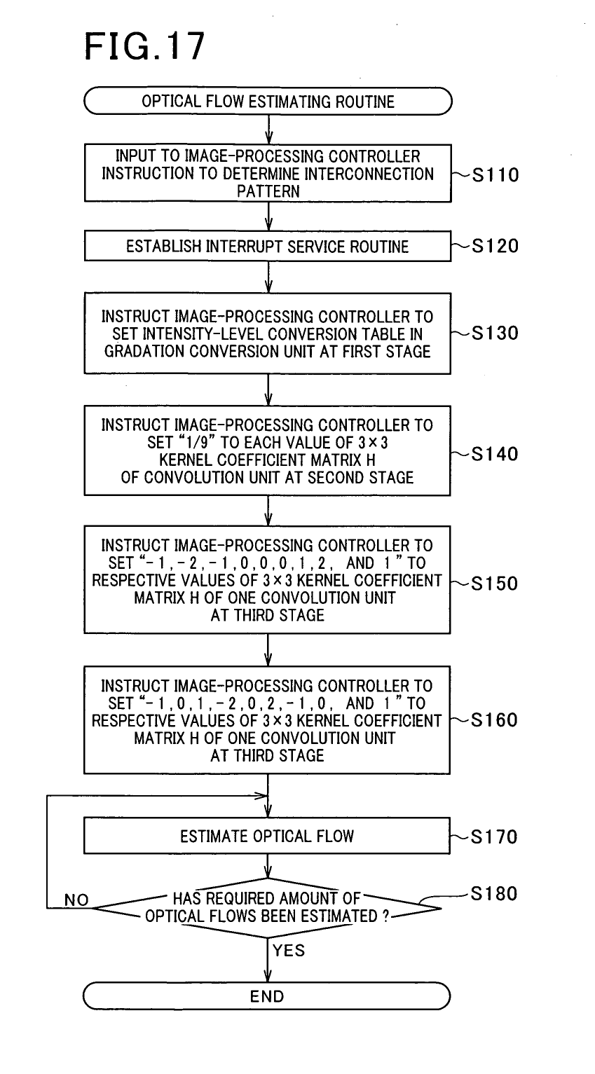

In the fourth embodiment, the microcomputer 21 is programmed to carry out an optical flow estimating routine illustrated in FIG. 17 to thereby determine the one of the interconnection patterns for the preprocessing task of the gradient method for optical-flow estimation and estimate optical flows based on the result of the preprocessing task.

FIG. 17 schematically illustrates the optical flow estimating routine to be carried out by the microcomputer 21. For example, the microcomputer 21 is programmed to periodically carry out the optical flow estimating routine.

When launching the optical flow estimating routine, the microcomputer 21 inputs, to the image-processing controller 17, an instruction for determining the one of the interconnection patterns among the processing units 81a1 to 81a9 for the preprocessing task of the gradient method for optical-flow estimation in step S110. This allows the image-processing controller 17 to send the control signals to the image processor 134, and the control signals allow the image processor 134 to determine the one of the interconnection patterns among the processing units 81a1 to 81a9 for the preprocessing task of the gradient method for optical-flow estimation (see FIG. 16A).

Specifically, the gradation unit 81a5 is set as the first stage, the convolution unit 81a1 is set as the second stage to be connected in series to the first stage, and the parallely connected convolution units 81a2 and 81a3 are set as the third stage to be connected in series to the second stage. In addition, the convolution unit 81a1 at the second stage, and the convolution units 81a2 and 81a3 at the third stage are selected by the output selector 90 as final stages in the pipelined architecture of the processing units 81a1, 81a2, 81a3, and 81a5. This allows image data outputted from each of the convolution unit 81a1 at the second stage and convolution units 81a2 and 81a3 at the third stage to be written into the image memory 15.

After completion of the operation in step S110, the microcomputer 21 proceeds to step S120. In step S120, the microcomputer 21 establishes an interrupt service routine in the image-processing controller 17 especially for the interrupt input unit 20.

Specifically, the interrupt service routine causes the interrupt input unit 20 to input, to the microcomputer 21, an interrupt request every time:

output of one frame video data from the convolution unit 81a1 at the second stage has been completed; and

output of one frame video data from each of the convolution units 81a1 and 81a3 at the third stage has been completed.

After completion of the operation in step S120, the microcomputer 21 instructs the image-processing controller 17 to set the intensity-level conversion table T1 for contrast adjustment in the gradation conversion unit 81a5 as the first stage. The intensity-level conversion table T1 consists of a predetermined bit value corresponding to a predetermined alternative intensity level for each pixel of frame video data inputted to the gradation conversion unit 81a5. Based on the intensity-level conversion table T1, the gradation conversion unit 81a5 can transform the bit value (intensity level) of each pixel of frame video data inputted thereto to a predetermined alternative bit value (intensity level) stored in the intensity-level conversion table T1 to be associated with a corresponding one pixel.

After completion of the operation in step S130, the microcomputer 21 instructs the image-processing controller 17 to set “ 1/9” to each value of the 3×3 kernel coefficient matrix H of the convolution unit 81a1 at the second stage so that the 3×3 kernel coefficient matrix H consists of “ 1/9, 1/9, 1/9, 1/9, 1/9, 1/9, 1/9, 1/9, and 1/9” in step S140.

Next, in order to generate gradient image data in the x direction, the microcomputer 21 instructs the image-processing controller 17 to set “−1, −2, −1, 0, 0, 0, 1, 2, and 1” to the respective values of the 3×3 kernel coefficient matrix H of the convolution unit 81a2 at the third stage so that the 3×3 kernel coefficient matrix H consists of “1, −2, −1, 0, 0, 0, 1, 2, and 1” in step S150.

Next, in order to generate gradient image data in the y direction, the microcomputer 21 instructs the image-processing controller 17 to set “−1, 0, 1, −2, 0, 2, −1, 0, and 1” to the respective values of the 3×3 kernel coefficient matrix H of the convolution unit 81a3 at the third stage so that the 3×3 kernel coefficient matrix H consists of “−1, 0, 1, −2, 0, 2, −1, 0, and 138 in step S160.

This allows, when frame video data is inputted to the image processor 134 having the one of the interconnection patterns for the preprocessing task of the gradient method for optical-flow estimation, the pipelined arhitecture of the processing units 81a1, 81a2, 81a3, and 81a5 illustrated in FIG. 16A to perform the preprocessing task of the gradient method for optical-flow estimation. As a result, the smoothed image data, the gradient image data in the x direction, and the gradient image data in the y direction corresponding to the frame video data inputted from the video input unit 11 to the image processor 134 are outputted from the convolution units 81a1, 81a2, and 81a3 to be stored in the image memory 15.

Specifically, every time the smoothed image data, the gradient image data in the x direction, and the gradient image data in the y direction corresponding to the frame video data inputted from the video input unit 11 are stored in the image memory 15, an interrupt request is inputted from the interrupt input unit 20 to the microcomputer 21.

Thus, in response to receiving the interrupt request, the microcomputer 21 reads out the smoothed image data, the gradient image data in the x direction. Based on the readout smoothed image data, gradient image data in the x direction, and gradient image data in the y direction, the microcomputer 21 estimates optical flows in step S170.

The microcomputer 21 repeatedly performs the operation in step S170 until it is determined that a required amount of optical flows has been estimated.

When it is determined that a required amount of optical flows has been estimated (the determination in step S150 is YES), the microcomputer 21 exits the optical flow estimating routine.

In order to perform the edge-detection task by the image processor 134, the image processor 134 selects a first alternative one of the interconnection patterns among the processing units 81a1 to 81a9 in accordance with the control signals inputted from the selector switching unit 19 of the image-processing controller 17.

FIG. 16B shows the selected first alternative one of the interconnection patterns among the processing units 81a1 to 81a9 for the edge-detection task in that:

the gradation conversion unit 81a5 is set as the first stage;

the parallely connected convolution units 81a1 and 81a2 are set as the second stage to be connected in series to the first stage;

the inter-image processing unit is set as the third stage to be connected in series to the second stage;

the gradation conversion unit 81a6 is set as the fourth stage to be connected in series to the third stage; and

the convolution unit 81a3 is set as the fifth stage to be connected in series to the fourth stage.

In accordance with the control signals inputted from the selector switching unit 19 of the image-processing controller 17, the output selector 90 selects the data output line 91a3 for the convolution unit 81a3 at the fifth stage.

This allows edge-enhanced image data outputted from the convolution unit 81a3 to be written into the image memory 15.

Specifically, in the fourth embodiment, the image processor 134 is configured to perform the edge-detecting task. This allows the microcomputer 21 to generate edge enhanced images based on the edge-enhanced image data stored in the image memory 15.

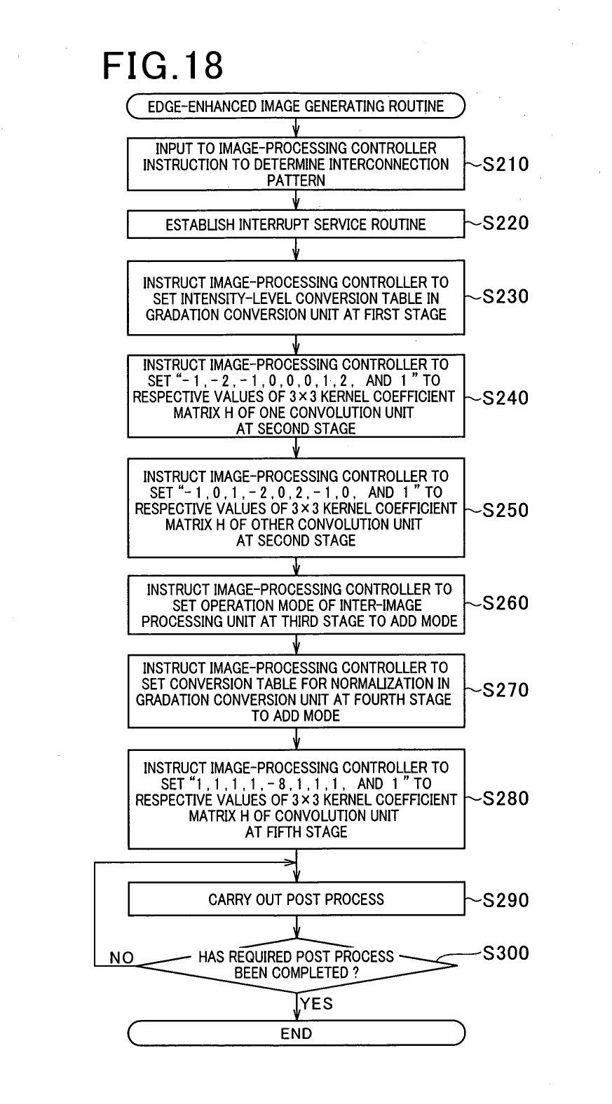

In the fourth embodiment, the microcomputer 21 is programmed to carry out an edge-enhanced image generating routine illustrated in FIG. 18 to thereby determine the first alternative one of the interconnection patterns for the edge-detection task.

FIG. 18 schematically illustrates the edge-enhanced image generating routine to be carried out by the microcomputer 21. For example, the microcomputer 21 is programmed to periodically carry out the edge-enhanced image generating routine.

When launching the edge-enhanced image generating routine, the microcomputer 21 inputs, to the image-processing controller 17, an instruction for determining the first alternative one of the interconnection patterns among the processing units 81a1 to 81a9 for the edge-detecting task in step S210. This allows the image-processing controller 17 to send the control signals to the image processor 134, and the control signals allow the image processor 134 to determine the first alternative one of the interconnection patterns among the processing units 81a1 to 81a9 for the edge-detecting task (see FIG. 16B).

After completion of the operation in step S210, the microcomputer 21 proceeds to step S220. In step S220, the microcomputer 21 establishes an interrupt service routine in the image-processing controller 17 especially for the interrupt input unit 20.

Specifically, the interrupt service routine causes the interrupt input unit 20 to input, to the microcomputer 21, an interrupt request every time output of one frame video data from the convolution unit 81a3 at the fifth stage has been completed.

After completion of the operation in step S220, the microcomputer 21 instructs the image-processing controller 17 to set the intensity-level conversion table T1 for contrast adjustment in the gradation conversion it 81a5 as the first stage in step S230.

After completion of the operation in step S230, in order to generate gradient image data in the x direction, the microcomputer 21 instructs the image-processing controller 17 to set “−1, −2, −1, 0, 0, 0, 1, 2, and 1” to the respective values of the 3×3 kernel coefficient matrix H of one of the convolution units 81a1 and 81a2 at the second stage so that the 3×3 kernel coefficient matrix H consists of “−1, −2, −1, 0, 0, 0, 1, 2, and 1” in step S240.

Next, in order to generate gradient image data in the y direction, the microcomputer 21 instructs the image-processing controller 17 to set “−1, 0, 1 −2, 0, 2, 1, 0, and 1” to the respective values of the 3×3 kernel coefficient mat H of the other of the convolution units 81a1 and 81a2 at the second stage so that the 3×3 kernel coefficient matrix H consists of “−1, 0, 1, −2, 0, 2, −1, 0, and 1” in step S250.

Next, the microcomputer 21 instructs the image-processing controller 17 to set the operation mode of the inter-image processing unit 81a9 at the third stage to an add mode in step S260. The inter-image processing unit 81a9 in the add mode is configured to add the gradient image data in the x direction and that in the y direction.

Next, the microcomputer 21 instructs the image-processing controller 17 to set a conversion table for normalization in the gradation conversion unit 81a6 at the fourth stage in step S270.

Next, in order to perform edge enhancement, the microcomputer 21 instructs the image-processing controller 17 to set “−1, 1, 1, 1, −8, 1, 1, 1, and 1” to the respective values of the 3×3 kernel coefficient matrix H of the convolution unit 81a3 at the five stage so that the 3×3 kernel coefficient matrix H consists of “1, 1, 1, 1, −8, 1, 1, 1, and 1” in step S280.

This allows, when frame video data is inputted to the image processor 134 having the first alternative one of the interconnection patterns for the edge-detection task, the pipelined architecture of the processing units 81a1, 81a2, 81a3, 81a5, 81a6, and 81a9 illustrated in FIG. 16B to perform the edge-detection task. As a result, the edge-enhanced image data corresponding to the frame video data inputted from the video input unit 11 to the image processor 134 is outputted from the convolution unit 81a3 to be stored in the image memory 15.

Specifically, every time the edge-enhanced image data corresponding to the frame video data inputted from the video input unit 11 is stored in the image memory 15, an interrupt request is inputted from the interrupt input unit 20 to the microcomputer 21.

Thus, in response to receiving the interrupt request, the microcomputer 21 reads out the edge-enhanced image data. Based on the readout edge-enhanced image data, the microcomputer 21 carries out at least one post process in step S290.

The microcomputer 21 repeatedly performs the operation in step S290 until it is determined that at least one required post process has been completed.

When it is determined that at least one required post process has been completed (the determination in step S300 is YES), the microcomputer 21 exits the edge-enhanced image generating routine.

In order to perform the preprocessing task of labeling by the image processor 134, the image processor 134 selects a second alternative one of the interconnection patterns among the processing units 81a1 to 81a9 in accordance with the control signals inputted from the selector switching unit 19 of the image-processing controller 17.

FIG. 16C shows the selected second alternative one of the interconnection patterns among the processing units 81a1 to 81a9 for the preprocessing task of labeling in that:

the gradation conversion unit 81a5 is set as the first stage;

the convolution unit 81a1 is set as the second stage to be connected in series to the first stage;

the gradation conversion unit 81a6 is set as the third stage to be connected in series to the second stage;

the erosion unit 81a7 is set as the fourth stage to be connected in series to the third stage; and

the dilation unit 81a8 is set as the fifth stage to be connected in series to the fourth stage.

In accordance with the control signals inputted from the selector switching unit 19 of the image-processing controller 17, the output selector 90 selects the data output line 91a8 for the dilation unit 81a8 at the fifth stage.

This allows the image processor 134 to perform the preprocessing task of labeling.

In order to perform the filtering task with the 5×5 kernel coefficient matrix by the image processor 134, the image processor 134 selects a third alternative one of the interconnection patterns among the processing units 81a1 to 81a9) in accordance with the control signals inputted from the selector switching unit 19 of the image-processing controller 17.

FIG. 16D shows the selected third alternative one of the interconnection patterns among the processing units 81a1 to 81a9 for the filtering task with the 5×5 kernel coefficient matrix in that:

frame video data flowing through the data input line 93 is directly inputted to each of the convolution units 81a1, 81a2, 81a3, and 81a4.

In accordance with the control signals inputted from the selector switching unit 19 of the image-processing controller 17, the output selector 90 selects the data output line 89 of the combining unit 85.

This allows the image processor 134 to perform the filtering task with the 5×5 kernel coefficient matrix.

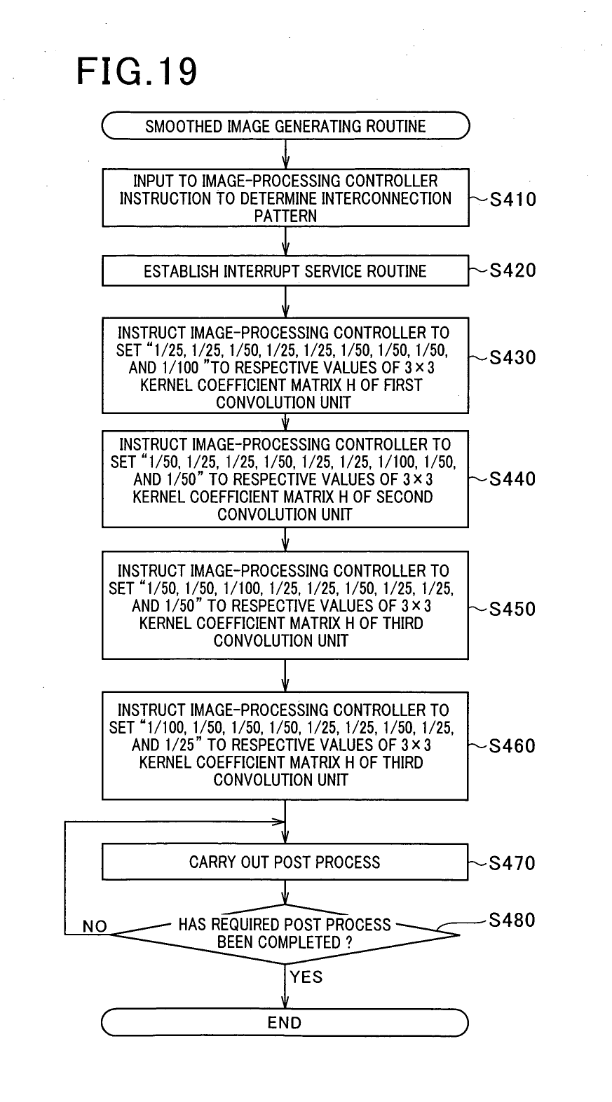

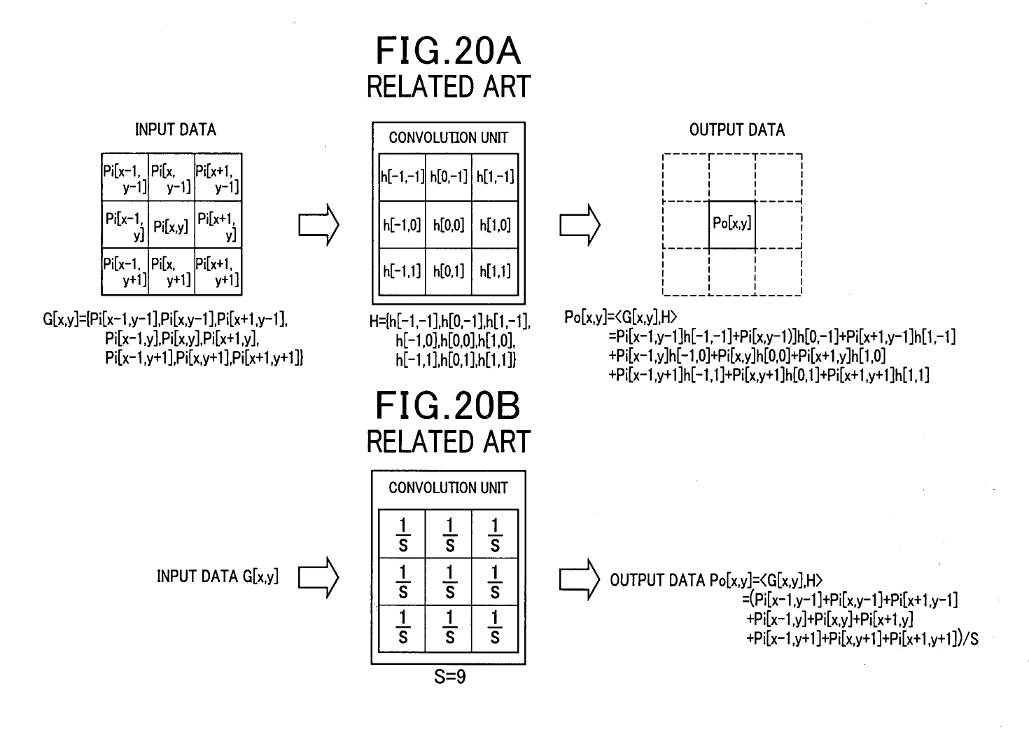

FIG. 19 schematically illustrates a smoothed image generating routine to be carried out by the microcomputer 21. For example, the microcomputer 21 is programmed to periodically carry out the smoothed image generating routine.

When launching the smoothed image generating routine, the microcomputer 21 inputs, to the image-processing controller 17, an instruction for determining the third alternative one of the interconnection patterns among the processing units 81a1 to 81a9 for the edge-detecting task in step S410. This allows the image-processing controller 17 to send the control signals to the image processor 134, and the control signals allow the image processor 134 to determine the third alternative one of the interconnection patterns among the processing units 81a1 to 81a9 for the edge-detecting task (see FIG. 16D).

After completion of the operation in step S410, the microcomputer 21 proceeds to step S420. In step S420, the microcomputer 21 establishes an interrupt service routine in the image-processing controller 17 especially for the interrupt input unit 20.

Specifically, the interrupt service routine causes the interrupt input unit 20 to input, to the microcomputer 21, an interrupt request every the output of one frame video data from the combining unit 85 has been completed.

After completion of the operation in step S420, the microcomputer 21 instructs the image-processing controller 17 to set “ 1/25, 1/25, 1/50, 1/25, 1/25, 1/50, 1/50, 1/50, and 1/100” to the respective values of the 3×3 kernel coefficient matrix H of the first convolution unit 81a1 so that the 3×3 kernel coefficient matrix H consists of “ 1/25, 1/25, 1/50, 1/25, 1/25, 1/50, 1/50, 1/50, and 1/100” in step S430.

Next, the microcomputer 21 instructs the image-processing controller 17 to set “ 1/50, 1/25, 1/25, 1/30, 1/25, 1/25, 1/100, 1/50, and 1/50” to the respective values of the 3×3 kernel coefficient matrix H of the second convolution unit 81a2 so that the 3×3 kernel coefficient matrix H consists of “ 1/50, 1/25, 1/25, 1/50, 1/25, 1/25, 1/100, 1/50, and 1/50” in step S440.

Next, the microcomputer 21 instructs the image-processing controller 17 to set “ 1/50, 1/50, 1/100, 1/25, 1/25, 1/50, 1/25, 1/25, and 1/50”, to the respective values of the 3×3 kernel coefficient matrix H of the third convolution unit 81a3 so that the 3×3 kernel coefficient matrix H consists of “ 1/50, 1/50, 1/100, 1/25, 1/25, 1/50, 1/25, 1/25, and 1/50” in step S450.

Next, the microcomputer 21 instructs the image-processing controller 17 to set “ 1/100, 1/50, 1/50, 1/50, 1/25, 1/25, 1/50, 1/25, and 1/25” to the respective values of the 3×3 kernel coefficient max H of the fourth convolution unit 81a4 so that the 3×3 kernel coefficient matrix H consists of “ 1/100, 1/50, 1/50, 1/50, 1/25, 1/25, 1/50, 1/25, and 1/25” in step S460.

This allows, when frame video data is inputted to the image processor 134 having the third alternative one of the interconnection patterns for the smoothed image generating task, the pipelined architecture of the processing units 81a1, 81a2, 81a8, and 81a4 illustrated in FIG. 16D and the combining it 85 to perform the smoothed image generating task. As a result, the smoothed image data corresponding to the frame video data inputted from the video input unit 11 to the image processor 134 is outputted from the convolution unit 85 to be stored in the image memory 15.

Specifically, every time the smoothed image data corresponding to the frame video data inputted from the video input unit 11 is stored in the image memory 15, an interrupt request is inputted from the interrupt input unit 20 to the microcomputer 21.

Thus, in response to receiving the interrupt request, the microcomputer 21 reads out the smoothed image data. Based on the readout smoothed image data, the microcomputer 21 carries out at least one post process in step S470.

The microcomputer 21 repeatedly performs the operation in step S460 until it is determined that at least one required post process has been completed.

When it is determined that at least one required post process has been completed (the determination in step S470 is YES), the microcomputer 21 exits the smoothed image generating routine.

As described above, the information processing device according to the fourth embodiment is configured to merely control each of the input selectors 83a1 to 83a9 and the output selector 90 to thereby switchably select any one of the interconnection patterns among the processing units 81a1 to 81a9 integrated in the image processor 13 (134). This allows the information processing device 1 to carries out various image-processing tasks corresponding to the respective interconnection patterns; these tasks include the preprocessing task of a gradient method for optical-flow estimation, the edge-detection task, the preprocessing task of labeling, and the filtering task with a 5×5 kernel coefficient matrix.

Specifically, in the single information processing device 1 according to the fourth embodiment, it is possible to effectively share the convolution units 81a1 to 81a4, the gradation conversion units 81a5 and 81a6, and the like so as to carry out the preprocessing task of a gradient method for optical-flow estimation, the edge-detection task, the preprocessing task of labeling, and the filtering task with a 5×5 kernel coefficient matrix.

Accordingly, the image processor 134 can be compact in design while carrying out the various image-processing tasks. This makes it possible for the information processing device according to the fourth embodiment to carry out the various image-processing tasks faster than conventional information processing units.

In the first to fourth embodiments, pieces of frame video data based on picked-up frame images are configured to be inputted to the image processors 13 (131, 133, and 134) so that they are subjected to the various image-processing tasks thereby, but the present invention is not limited to the configuration.

Specifically, pieces of information can be configured to be inputted to the image processors 13 (131, 133, and 134) so that they are subjected to the various processing tasks thereby.

In the third embodiment, the first to fourth FIFO line buffers 71a to 71d are provided for the respective processing units 31a to 31d, but the fourth FIFO buffer 71d can be omitted. This is because the image processor 133 according to the third embodiment can obtain, based on the processing units 31a to 31d with the m×m kernel coefficient matrix, the result of an n×n matrix convolution without using the fourth FIFO line buffer 71d for the fourth processing unit 31d.

The number of processing units and the types thereof to be installed in the image processors 13 (131, 133, and 134) can be changed.

While there has been described what is at present considered to be the embodiments and their modifications of the present invention, it will be understood that various modifications which are not described yet may be made therein, and it is intended to cover in the appended claims all such modifications as fall within the the spirit and scope of the invention.

What is claimed is:

1. A pipeline device comprising:
a plurality of data transfer lines including: a data input line through which data is inputted, and a plurality of data output lines;
a plurality of processing units each having an input and an output, the output of each of the plurality of processing units being connected to a corresponding one of the data output lines, and
a plurality of input selectors provided for the plurality of processing units, respectively, each of the plurality of input selectors working to:
select one of the plurality of data transfer lines except for one data output line to which the output of a corresponding one of the plurality of processing units is connected to thereby determine one of a plurality of interconnection patterns among the plurality of processing units, the plurality of interconnection patterns corresponding to a plurality of data-processing tasks, respectively; and
input, to a corresponding one of the plurality of processing units via the input thereof, data flowing through the selected one of the plurality of data transfer lines, each of the plurality of processing units working to individually carry out a predetermined process based on data inputted thereto by a corresponding one of the plurality of input selectors to thereby carry out, in pipeline, one of the plurality of data-processing tasks corresponding to the determined one of the plurality of interconnection patterns.

2. A pipeline device according to claim 1, wherein the pipeline device is connected to a controller, the controller working to input, to the pipeline device, a control signal, the control signal representing one of the plurality of interconnection patterns, each of the plurality of input selectors working to select one of the plurality of data transfer lines except for one data output line to which the output of a corresponding one of the plurality of processing units is connected in accordance with the control signal to thereby determine one of the plurality of interconnection patterns among the plurality of processing units.

3. A pipeline device according to claim 1, wherein the plurality of processing units are a plurality of convolution units, each of the plurality of convolution units having a kernel coefficient matrix with a predetermined size and working to convolve data inputted thereto based on the kernel coefficient matrix and output a convolved result, further comprising:
a combining unit connected to each of the plurality of convolution units and working to combine the convolved results outputted from the plurality of convolution units to thereby carry out a convolution based on a kernel coefficient matrix with a size greater than the size of the kernel coefficient matrix of each of the plurality of convolution units.

4. A pipeline device according to claim 3, wherein the plurality of convolution its work to respectively output the convolved results at different timings, the combining unit comprises a delay circuit and a total sum calculating unit,
the delay circuit being configured to:
temporarily store at least one of the convolved results outputted from the plurality of convolution units so as to delay the at least one of the convolved results by a predetermined period; and
output, to the total sum calculating circuit, the at least one of the convolved results delayed thereby such that the convolved results outputted from the plurality of convolution units are inputted to the total sum calculating circuit in synchronization with each other,
the total sum calculating circuit working to:
receive the convolved results inputted thereto; and
calculate a sum of the received convolved results to thereby obtain a result of the convolution based on the kernel coefficient matrix with the size greater than the size of the kernel coefficient matrix of each of the plurality of convolution units.

5. A pipeline device according to claim 1, further comprising:
a plurality of enable-signal transfer lines including: an enable-signal input line through which an enable signal is inputted, and a plurality of enable signal output lines;
a plurality of delay units provided for the plurality of processing units, respectively, each of the plurality of delay units having an input and an output, the output of each of the plurality of delay units being connected to a corresponding one of the enable-signal output lines, each of the plurality of delay units working to:
receive the enable signal, the enable signal enabling a corresponding one of the plurality of processing unit to input data; and
delay an output of the received enable signal by a predetermined period required for a corresponding one of the plurality of processing units to perform the corresponding predetermined process and to output a result of the corresponding predetermined process;
a plurality of first signal input selectors provided for the plurality of delay units, each of the plurality of first signal input selectors working to:
select one of the plurality of enable-signal transfer lines except for one enable-signal output line to which the output of a corresponding one of the plurality of delay units is connected; and
input, to a corresponding one of the plurality of delay units, an enabling signal flowing through the selected one of the plurality of enable-signal transfer lines to thereby determine one of a plurality of interconnection patterns among the plurality of first signal input selectors to be matched with the determined one of the plurality of interconnection patterns among the plurality of processing units; and
a plurality of second signal input selectors provided for the plurality of processing units and connected to the plurality of enable-signal transfer lines, respectively, each of the plurality of second signal input selectors working to:
select one of the plurality of enable-signal transfer lines; and
input, to a corresponding one of the plurality of processing units, an enabling signal flowing through the selected one of the plurality of enable-signal transfer lines to thereby determine one of a plurality of enable-signal input patterns between the plurality of second signal input selectors and the plurality of processing units to be matched with the determined one of the plurality of interconnection patterns among the plurality of processing units.

6. A pipeline device according to claim 1, further comprising:
a plurality of enable-signal transfer lines including an enable-signal input line through which an enable signal is inputted, and a plurality of enable signal output lines, each of the plurality of enable signal output lines being connected to an alternative output of a corresponding one of the plurality of processing unit;
a plurality of signal input selectors provided for the plurality of processing units, respectively, each of the plurality of signal input selectors working to:
select one of the plurality of enable-signal transfer lines; and
input, to a corresponding one of the plurality of processing units, an enabling signal flowing rough the selected one of the plurality of enable-signal transfer lines to thereby determine one of a plurality of interconnection patterns among the plurality of signal input selectors to be matched with the determined one of the plurality of interconnection patterns among the plurality of processing units,
each of the plurality of processing units working to:
receive the enable signal, the enable signal enabling a corresponding one of the plurality of processing unit to input data; and
delay an output of the received enable signal by a predetermined period required for a corresponding one of the plurality of processing units to perform the corresponding predetermined process and to output, to a corresponding one of the plurality of enable-signal output lines, a result of the corresponding predetermined process.

7. A pipeline device according to claim 5, wherein the pipeline device is connected to a microcomputer, the microcomputer working to carry out information processing based on a result of the predetermined process by each of the plurality of processing units, further comprising:
an interrupt input unit working to input, to the microcomputer, an interrupt request in accordance with the enable signal flowing through each of the enable signal output lines, the interrupt request allowing the microcomputer to grasp timing of data to be inputted to each of the plurality of processing units.

8. A pipeline device according to claim 6, wherein the pipeline device is connected to a microcomputer, the microcomputer working to carry out information processing based on a result of the predetermined process by each of the plurality of processing units, further comprising:
an interrupt input unit working to input, to the microcomputer, an interrupt request in accordance with the enable signal flowing through each of the enable signal output lines, the interrupt request allowing the microcomputer to grasp timing of data to be inputted to each of the plurality of processing units.

9. A pipeline device according to claim 1, wherein the data is pixel data of each pixel of frame video data corresponding to a frame video image, the pixel data is inputted to the data-processing apparatus through the data input line pixel by pixel, and the plurality of data-processing tasks include a preprocessing task of a gradient method for optical-flow estimation, an edge-detection task, a preprocessing task of labeling, and a filtering task with a 5×5 kernel coefficient matrix.

10. A data-processing apparatus comprising:
a plurality of data transfer lines including: a data input line through which data is inputted, and a plurality of data output lines;
a plurality of processing units each having an input and an output, the output of each of the plurality of processing units being connected to a corresponding one of the data output lines;
a plurality of input selectors provided for the plurality of processing units, respectively; and
a controller working to input, to the plurality of input selectors, a control signal representing one of a plurality of interconnection patterns among the plurality of processing units, the plurality of interconnection patterns corresponding to a plurality of data-processing tasks, respectively,
each of the plurality of input selectors working to:
select one of the plurality of data transfer lines except for one data output line to which the output of a corresponding one of the plurality of processing units is connected to thereby determine one of the plurality of interconnection patterns among the plurality of processing units; and
input, to a corresponding one of the plurality of processing units via the input thereof, data flowing through the selected one of the plurality of data transfer lines, each of the plurality of processing units working to individually can out a predetermined process based on data inputted thereto by a corresponding one of the plurality of input selectors to thereby carry out, in pipeline, one of the plurality of data-processing tasks corresponding to the determined one of the plurality of interconnection patterns.

11. A data-processing apparatus according to claim 10, wherein the data is pixel data of each pixel of frame video data corresponding to a frame video image, the pixel data is inputted to the data-processing apparatus through the data input line pixel by pixel, and the plurality of data-processing tasks include a preprocessing task of a gradient method for optical-flow estimation, an edge-detection task, a preprocessing task of labeling, and a filtering task with a 5×5 kernel coefficient matrix.

12. A data-processing apparatus according to claim 10, further comprising:
a plurality of enable-signal transfer lines including: an enable-signal input line through which an enable signal is inputted, and a plurality of enable signal output lines;
a plurality of delay units provided for the plurality of processing units, respectively, each of the plurality of delay units having an input and an output, the output of each of the plurality of delay units being connected to a corresponding one of the enable-signal output lines, each of the plurality of delay units working to:
receive the enable signal, the enable signal enabling a corresponding one of the plurality of processing unit to input data; and
delay an output of the received enable signal by a predetermined period required for a corresponding one of the plurality of processing units to perform the corresponding predetermined process and to output a result of the corresponding predetermined process;
a plurality of first signal input selectors operatively connected to the controller and provided for the plurality of delay units, each of the plurality of first signal input selectors working to:
select one of the plurality of enable-signal transfer lines except for one enable-signal output line to which the output of a corresponding one of the plurality of delay units is connected; and
input, to a corresponding one of the plurality of delay units, an enabling signal flowing through the selected one of the plurality of enable-signal transfer lines under control of the controller to thereby determine one of a plurality of interconnection patterns among the plurality of first signal input selectors to be matched with the determined one of the plurality of interconnection patterns among the plurality of processing units; and
a plurality of second signal input selectors operatively connected to the controller and provided for the plurality of processing units and connected to the plurality of enable-signal transfer lines, respectively, each of the plurality of second signal input selectors working to:
select one of the plurality of enable-signal transfer lines; and
input, to a corresponding one of the plurality of processing units, an enabling signal flowing through the selected one of the plurality of enable-signal transfer lines under control of the controller to thereby determine one of a plurality of enable-signal input patterns between the plurality of second signal input selectors and the plurality of processing units to be matched with the determined one of the plurality of interconnection patterns among the plurality of processing units.

13. A data-processing apparatus according to claim 10, further comprising:
a plurality of enable-signal transfer lines including: an enable-signal input line trough which an enable signal is inputted, and a plurality of enable signal output lines, each of the plurality of enable signal output lines being connected to an alternative output of a corresponding one of the plurality of processing units;
a plurality of signal input selectors operatively connected to the controller and provided for the plurality of processing units, respectively, each of the plurality of signal input selectors working to:
select one of the plurality of enable-signal transfer lines; and
input, to a corresponding one of the plurality of processing units, an enabling signal flowing through the selected one of the plurality of enable-signal transfer lines under control of the controller to thereby determine one of a plurality of interconnection patterns among the plurality of signal input selectors to be matched with the determined one of the plurality of interconnection patterns among the plurality of processing units,
each of the plurality of processing units working to:
receive the enable signal, the enable signal enabling a corresponding one of the plurality of processing unit to input data; and
delay an output of the received enable signal by a predetermined period required for a corresponding one of the plurality of processing units to perform the corresponding predetermined process and to output, to a corresponding one of the plurality of enable-signal output lines, a result of the corresponding predetermined process.
